(19) United States
(12) Patent Application Publication
(10) Pub. No.: US 2025/0258620 A1
(43) Pub. Date: Aug. 14, 2025

(54) ONLINE DEDUPLICATION FOR VOLATILE MEMORY

(71) Applicant: Micron Technology, Inc., Boise, ID (US)

(72) Inventors: Nicola CORNA, Gorle (IT); Nicola DEL GATTO, Cassina De' Pecchi (IT)

(21) Appl. No.: 19/013,265

(22) Filed: Jan. 8, 2025

Related U.S. Application Data
(60) Provisional application No. 63/552,752, filed on Feb. 13, 2024.

(51) Int. Cl. G06F 3/06

(52) U.S. Cl. CPC G06F 3/0641; G06F 3/0608; G06F 3/0659; G06F 3/0673

(57) ABSTRACT

Implementations described herein relate to a system that includes volatile memory and a controller. The controller may receive a command to write data to the volatile memory, where the command indicates a logical address associated with the data. The controller may compare the data to one or more duplicate data patterns to identify whether the data matches the duplicate data pattern. The controller may map, responsive to the data matching the duplicate data pattern, a physical address associated with the duplicate data pattern to the logical address, without writing the data to the volatile memory.

### CROSS-REFERENCE TO RELATED APPLICATION

This Patent Application claims priority to U.S. Provisional Patent Application No. 63/552,752, filed on Feb. 13, 2024, and entitled “ONLINE DEDUPLICATION FOR VOLATILE MEMORY.” The disclosure of the prior Application is considered part of and is incorporated by reference into this Patent Application.

### TECHNICAL FIELD

The present disclosure generally relates to memory devices, memory device operations, and, for example, to online deduplication for volatile memory.

### BACKGROUND

Memory devices are widely used to store information in various electronic devices. A memory device includes memory cells. A memory cell is an electronic circuit capable of being programmed to a data state of two or more data states. For example, a memory cell may be programmed to a data state that represents a single binary value, often denoted by a binary “1” or a binary “0.” As another example, a memory cell may be programmed to a data state that represents a fractional value (e.g., 0.5, 1.5, or the like). To store information, an electronic device may write to, or program, a set of memory cells. To access the stored information, the electronic device may read, or sense, the stored state from the set of memory cells.

Various types of memory devices exist, including random access memory (RAM), read only memory (ROM), dynamic RAM (DRAM), static RAM (SRAM), synchronous dynamic RAM (SDRAM), ferroelectric RAM (FeRAM), magnetic RAM (MRAM), resistive RAM (RRAM), holographic RAM (HRAM), flash memory (e.g., NAND memory and NOR memory), and others. A memory device may be volatile or non-volatile. Non-volatile memory (e.g., flash memory) can store data for extended periods of time even in the absence of an external power source. Volatile memory (e.g., DRAM) may lose stored data over time unless the volatile memory is refreshed by a power source. In some examples, a memory device may be associated with a compute express link (CXL). For example, the memory device may be a CXL compliant memory device and/or may include a CXL interface.

### BRIEF DESCRIPTION OF THE DRAWINGS

FIG. 1 is a diagram illustrating an example system.

FIG. 2 is a diagram illustrating an example system.

FIG. 3 is a diagram illustrating a central controller and a memory device of a system.

FIG. 4A-4C are diagrams of an example of online deduplication for volatile memory.

FIGS. 5A-5E are diagrams of an example of online deduplication for volatile memory.

FIGS. 6A-6C are diagrams of an example of online deduplication for volatile memory.

FIGS. 7A-7C are diagrams of an example of block allocation.

FIG. 8 is a flowchart of an example method associated with online deduplication for volatile memory.

### DETAILED DESCRIPTION

Memory blocks are often duplicated in a system's memory. For example, two blocks may be duplicates when the respective data stored in the blocks are identical (e.g., the two blocks may each store the same sequence of bit values). This may occur when blocks are initialized but unused, when there are identical structures across multiple files of the same format that are loaded in memory, and/or when multiple identical files (e.g., the same library or kernel binary) are loaded in memory across different virtual machines hosted on the same system, among other examples.

Deduplication is a technique used to reduce the number of duplicate blocks in memory. Deduplication techniques may be classified as online (also referred to as in-band) or offline (also referred to as out-of-band). In online deduplication, the deduplication is performed during data writes to the memory. In offline deduplication, the deduplication is performed by retrospectively analyzing written data to identify duplicate blocks. Generally, deduplication techniques are implemented in software with a focus on storage deduplication. However, these software-based deduplication techniques are unsuitable for volatile memory due to the high performance requirements for volatile memory. In volatile memory, duplication of blocks consumes excessive memory resources and decreases memory capacity.

Some implementations described herein enable online deduplication for volatile memory. In some implementations, a memory controller (e.g., a CXL controller) may perform deduplication operations when executing commands to write data to the volatile memory. The memory controller may implement one or more data structures used to track data previously written to the volatile memory. When a command to write new data to the volatile memory is received, the new data may be compared against the data structure(s) to identify whether the new data is a duplicate of data previously written to the volatile memory. If so, a logical address for the new data may be mapped to a physical address in the volatile memory of the previously written data, without writing the new data to the volatile memory. In this way, a subsequent read command for the logical address will return the correct data (e.g., the previously written data is returned, which is a duplicate of the new data that was requested to be written for the logical address) even though the new data of the write command was not actually written to the volatile memory.

Accordingly, duplicate blocks of data can be written to the volatile memory a reduced number of times (e.g., only once). In some implementations, data that may be associated with frequent duplication can be written to (e.g., only once) and read from a local memory of the memory controller (rather than the volatile memory). In this way, this frequently duplicated data can be identified and read with improved speed and performance.

The online deduplication for volatile memory described herein conserves significant memory resources and increases memory capacity. The increased memory capacity can be used for additional user data and/or for storing management data (e.g., to reduce a number of memory dies that are needed). Moreover, the online deduplication for volatile memory described herein provides a significant reduction to a cost-per-byte of the volatile memory and is achieved using a small amount of additional resources of the memory controller while producing a minimal performance hit to the memory controller.

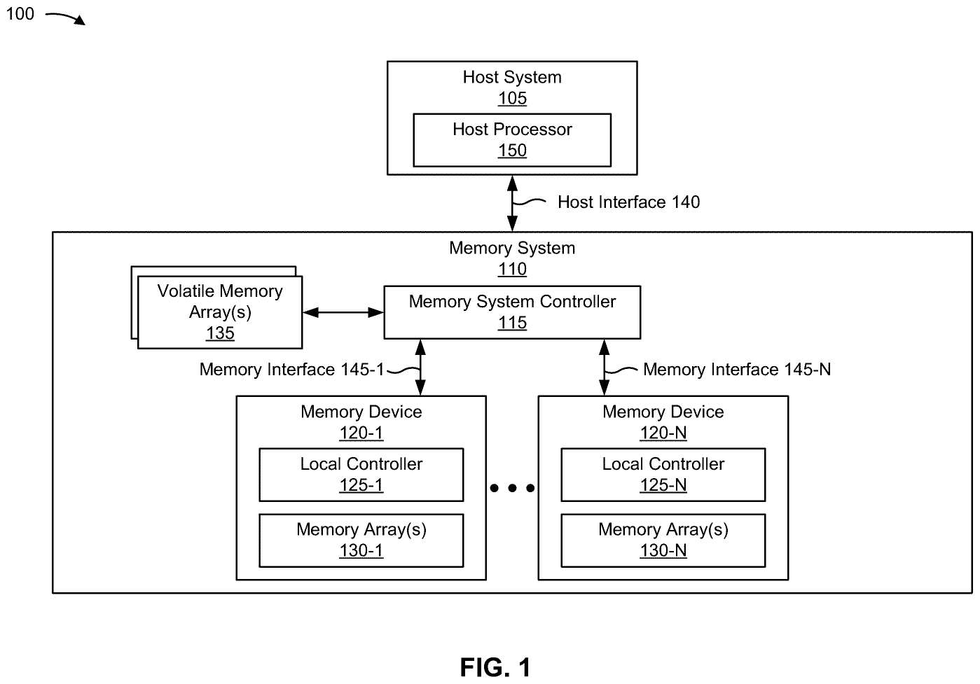

FIG. 1 is a diagram illustrating an example system 100. The system 100 may include one or more devices, apparatuses, and/or components for performing operations described herein. For example, the system 100 may include a host system 105 and a memory system 110. The memory system 110 may include a memory system controller 115 and one or more memory devices 120, shown as memory devices 120-1 through 120-N (where N≥1). A memory device may include a local controller 125 and one or more memory arrays 130. The host system 105 may communicate with the memory system 110 (e.g., the memory system controller 115 of the memory system 110) via a host interface 140. The memory system controller 115 and the memory devices 120 may communicate via respective memory interfaces 145, shown as memory interfaces 145-1 through 145-N (where N≥1).

The system 100 may be any electronic device configured to store data in memory. For example, the system 100 may be a computer, a mobile phone, a wired or wireless communication device, a network device, a server, a device in a data center, a device in a cloud computing environment, a vehicle (e.g., an automobile or an airplane), and/or an Internet of Things (IoT) device. The host system 105 may include a host processor 150. The host processor 150 may include one or more processors configured to execute instructions and store data in the memory system 110. For example, the host processor 150 may include a central processing unit (CPU), a graphics processing unit (GPU), a field-programmable gate array (FPGA), an application-specific integrated circuit (ASIC), and/or another type of processing component.

The memory system 110 may be any electronic device or apparatus configured to store data in memory. For example, the memory system 110 may be a hard drive, a solid-state drive (SSD), a flash memory system (e.g., a NAND flash memory system or a NOR flash memory system), a universal serial bus (USB) drive, a memory card (e.g., a secure digital (SD) card), a secondary storage device, a non-volatile memory express (NVMe) device, an embedded multimedia card (eMMC) device, a dual in-line memory module (DIMM), and/or a random-access memory (RAM) device, such as a dynamic RAM (DRAM) device or a static RAM (SRAM) device.

The memory system controller 115 may be any device configured to control operations of the memory system 110 and/or operations of the memory devices 120. For example, the memory system controller 115 may include control logic, a memory controller, a system controller, an ASIC, an FPGA, a processor, a microcontroller, and/or one or more processing components. In some implementations, the memory system controller 115 may communicate with the host system 105 and may instruct one or more memory devices 120 regarding memory operations to be performed by those one or more memory devices 120 based on one or more instructions from the host system 105. For example, the memory system controller 115 may provide instructions to a local controller 125 regarding memory operations to be performed by the local controller 125 in connection with a corresponding memory device 120.

A memory device 120 may include a local controller 125 and one or more memory arrays 130. In some implementations, a memory device 120 includes a single memory array 130. In some implementations, each memory device 120 of the memory system 110 may be implemented in a separate semiconductor package or on a separate die that includes a respective local controller 125 and a respective memory array 130 of that memory device 120. The memory system 110 may include multiple memory devices 120.

A local controller 125 may be any device configured to control memory operations of a memory device 120 within which the local controller 125 is included (e.g., and not to control memory operations of other memory devices 120). For example, the local controller 125 may include control logic, a memory controller, a system controller, an ASIC, an FPGA, a processor, a microcontroller, and/or one or more processing components. In some implementations, the local controller 125 may communicate with the memory system controller 115 and may control operations performed on a memory array 130 coupled with the local controller 125 based on one or more instructions from the memory system controller 115. As an example, the memory system controller 115 may be an SSD controller, and the local controller 125 may be a NAND controller.

A memory array 130 may include an array of memory cells configured to store data. For example, a memory array 130 may include a non-volatile memory array (e.g., a NAND memory array or a NOR memory array) or a volatile memory array (e.g., an SRAM array or a DRAM array). In some implementations, the memory system 110 may include one or more volatile memory arrays 135. A volatile memory array 135 may include an SRAM array and/or a DRAM array, among other examples. The one or more volatile memory arrays 135 may be included in the memory system controller 115, in one or more memory devices 120, and/or in both the memory system controller 115 and one or more memory devices 120. In some implementations, the memory system 110 may include both non-volatile memory capable of maintaining stored data after the memory system 110 is powered off and volatile memory (e.g., a volatile memory array 135) that requires power to maintain stored data and that loses stored data after the memory system 110 is powered off. For example, a volatile memory array 135 may cache data read from or to be written to non-volatile memory, and/or may cache instructions to be executed by a controller of the memory system 110.

The host interface 140 enables communication between the host system 105 (e.g., the host processor 150) and the memory system 110 (e.g., the memory system controller 115). The host interface 140 may include, for example, a Small Computer System Interface (SCSI), a Serial-Attached SCSI (SAS), a Serial Advanced Technology Attachment (SATA) interface, a Peripheral Component Interconnect Express (PCIe) interface, an NVMe interface, a USB interface, a Universal Flash Storage (UFS) interface, an eMMC interface, a double data rate (DDR) interface, and/or a DIMM interface.

In some examples, the memory device 120 may be a compute express link (CXL) compliant memory device 120. For example, the memory device 120 may include a PCIe/CXL interface (e.g., the host interface 140 may be associated with a PCIe/CXL interface). CXL is a high-speed CPU-to-device and CPU-to-memory interconnect designed to accelerate next-generation performance. CXL technology maintains memory coherency between the CPU memory space and memory on attached devices, which allows resource sharing for higher performance, reduced software stack complexity, and lower overall system cost. CXL is designed to be an industry open standard interface for high-speed communications. CXL technology is built on the PCIe infrastructure, leveraging PCIe physical and electrical interfaces to provide advanced protocol in areas such as input/output (I/O) protocol, memory protocol, and coherency interface.

The memory interface 145 enables communication between the memory system 110 and the memory device 120. The memory interface 145 may include a non- volatile memory interface (e.g., for communicating with non-volatile memory), such as a NAND interface or a NOR interface. Additionally, or alternatively, the memory interface 145 may include a volatile memory interface (e.g., for communicating with volatile memory), such as a DDR interface.

Although the example memory system 110 described above includes a memory system controller 115, in some implementations, the memory system 110 does not include a memory system controller 115. For example, an external controller (e.g., included in the host system 105) and/or one or more local controllers 125 included in one or more corresponding memory devices 120 may perform the operations described herein as being performed by the memory system controller 115. Furthermore, as used herein, a “controller” may refer to the memory system controller 115, a local controller 125, or an external controller. In some implementations, a set of operations described herein as being performed by a controller may be performed by a single controller. For example, the entire set of operations may be performed by a single memory system controller 115, a single local controller 125, or a single external controller. Alternatively, a set of operations described herein as being performed by a controller may be performed by more than one controller. For example, a first subset of the operations may be performed by the memory system controller 115 and a second subset of the operations may be performed by a local controller 125. Furthermore, the term “memory apparatus” may refer to the memory system 110 or a memory device 120, depending on the context.

A controller (e.g., the memory system controller 115, a local controller 125, or an external controller) may control operations performed on memory (e.g., a memory array 130), such as by executing one or more instructions. For example, the memory system 110 and/or a memory device 120 may store one or more instructions in memory as firmware, and the controller may execute those one or more instructions. Additionally, or alternatively, the controller may receive one or more instructions from the host system 105 and/or from the memory system controller 115, and may execute those one or more instructions. In some implementations, a non-transitory computer-readable medium (e.g., volatile memory and/or non-volatile memory) may store a set of instructions (e.g., one or more instructions or code) for execution by the controller. The controller may execute the set of instructions to perform one or more operations or methods described herein. In some implementations, execution of the set of instructions, by the controller, causes the controller, the memory system 110, and/or a memory device 120 to perform one or more operations or methods described herein. In some implementations, hardwired circuitry is used instead of or in combination with the one or more instructions to perform one or more operations or methods described herein. Additionally, or alternatively, the controller may be configured to perform one or more operations or methods described herein. An instruction is sometimes called a “command.”

For example, the controller (e.g., the memory system controller 115, a local controller 125, or an external controller) may transmit signals to and/or receive signals from memory (e.g., one or more memory arrays 130) based on the one or more instructions, such as to transfer data to (e.g., write or program), to transfer data from (e.g., read), to erase, and/or to refresh all or a portion of the memory (e.g., one or more memory cells, pages, sub-blocks, blocks, or planes of the memory). Additionally, or alternatively, the controller may be configured to control access to the memory and/or to provide a translation layer between the host system 105 and the memory (e.g., for mapping logical addresses to physical addresses of a memory array 130). In some implementations, the controller may translate a host interface command (e.g., a command received from the host system 105) into a memory interface command (e.g., a command for performing an operation on a memory array 130).

The number and arrangement of components shown in FIG. 1 are provided as an example. In practice, there may be additional components, fewer components, different components, or differently arranged components than those shown in FIG. 1. Furthermore, two or more components shown in FIG. 1 may be implemented within a single component, or a single component shown in FIG. 1 may be implemented as multiple, distributed components. Additionally, or alternatively, a set of components (e.g., one or more components) shown in FIG. 1 may perform one or more operations described as being performed by another set of components shown in FIG. 1.

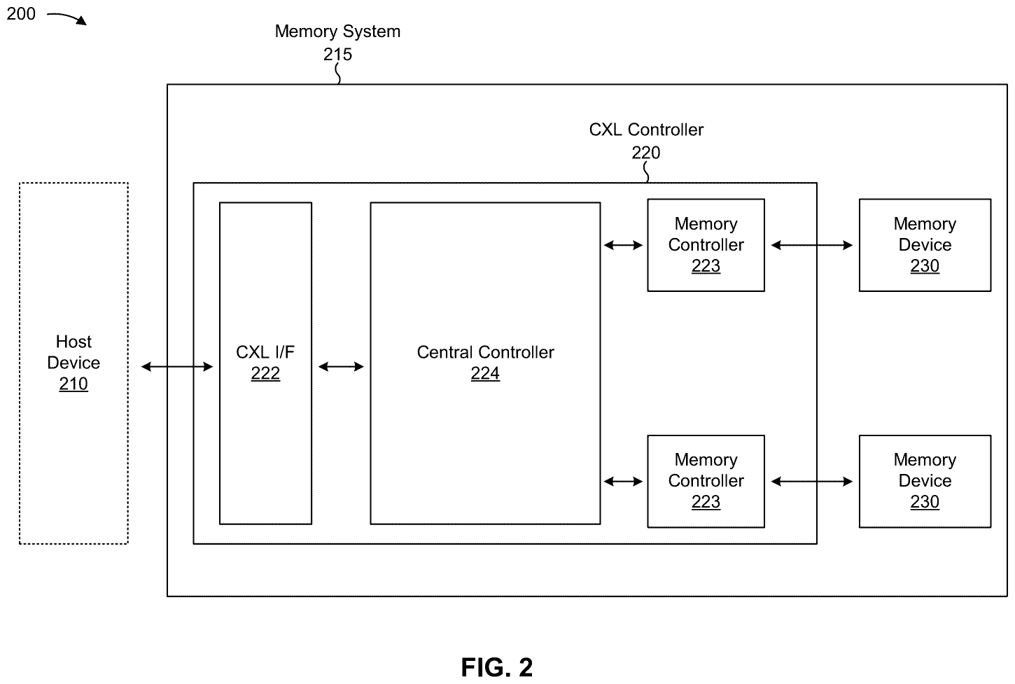

FIG. 2 is a diagram illustrating an example system 200. The system 200 may include one or more devices, apparatuses, and/or components for performing operations described herein. In some implementations, the system 200 is a CXL system. For example, the system 200 may include a host device 210, and a memory system 215 including a CXL controller 220 and one or more memory devices 230. The memory system 215 may correspond to the memory system 110. The host device 210 may include a CPU. In some implementations, the host device 210 corresponds to the host system 105 and/or the host processor 150. The memory device(s) 230 may include volatile memory. In some implementations, the memory device(s) 230 may include DRAM. In some implementations, the memory device(s) 230 may correspond to the memory devices 120.

The CXL controller 220 may include an ASIC, an FPGA, or the like. The CXL controller 220 may include a CXL interface 222, a central controller 224, and one or more memory controllers 223. In some implementations, the CXL interface 222 may correspond to the host interface 140. In some implementations, the memory controller(s) 223 may correspond to the memory system controller 115.

In some implementations, one or more systems, devices, apparatuses, components, and/or controllers of FIG. 1 and/or FIG. 2 may be configured to receive a command to write data to volatile memory, where the command indicates a logical address associated with the data; compare the data to one or more duplicate data patterns (“duplicate data pattern” may refer to a data pattern representative of data previously written to memory, or the underlying data itself, that can be used to identify whether new data to be written to memory is a duplicate of the data previously written) to identify whether the data matches a duplicate data pattern of the one or more duplicate data patterns; and map, responsive to the data matching the duplicate data pattern, a physical address associated with the duplicate data pattern to the logical address, without writing the data to the volatile memory.

In some implementations, one or more systems, devices, apparatuses, components, and/or controllers of FIG. 1 and/or FIG. 2 may be configured to receive a command to write data to volatile memory of the memory system, where the command indicates a logical address associated with the data; retrieve a duplicate data pattern using information in a local memory of the controller; compare the data to the duplicate data pattern to identify whether the data matches the duplicate data pattern; and map, responsive to the data matching the duplicate data pattern, a physical address associated with the duplicate data pattern to the logical address, without writing the data to the volatile memory.

The number and arrangement of components shown in FIG. 2 are provided as an example. In practice, there may be additional components, fewer components, different components, or differently arranged components than those shown in FIG. 2. Furthermore, two or more components shown in FIG. 2 may be implemented within a single component, or a single component shown in FIG. 2 may be implemented as multiple, distributed components. Additionally, or alternatively, a set of components (e.g., one or more components) shown in FIG. 2 may perform one or more operations described as being performed by another set of components shown in FIG. 2.

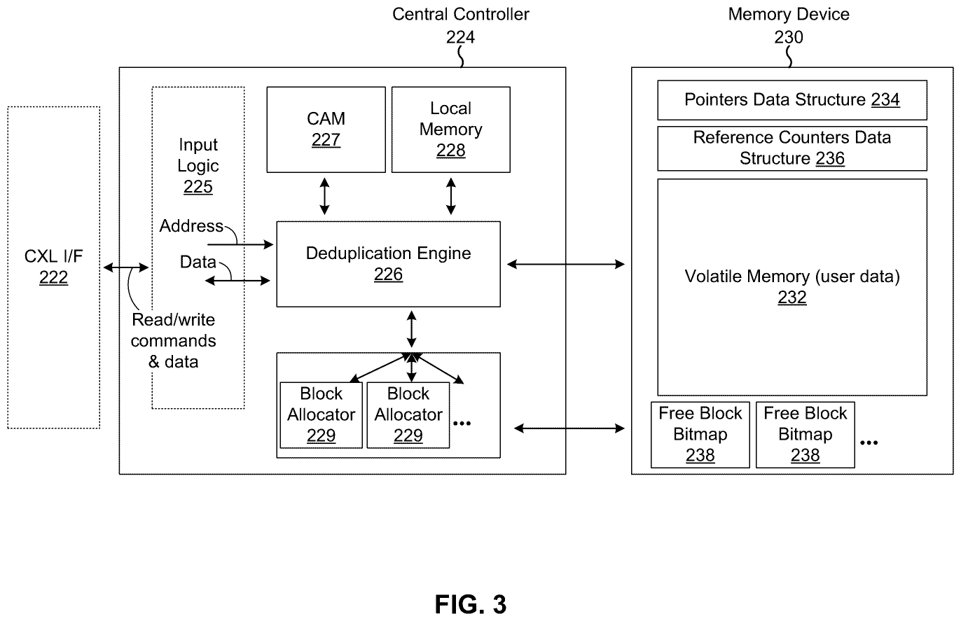

FIG. 3 is a diagram illustrating the central controller 224 and a memory device 230 of the system 200. As shown, the central controller 224 may include an input logic component 225, a deduplication engine 226, a content-addressable memory (CAM) 227, a local memory 228 (e.g., SRAM or other volatile memory), and one or more block allocators 229.

The input logic component 225 may be configured to receive read commands and/or write commands and/or exchange data with the CXL interface 222. Additionally, the input logic component 225 may be configured to provide address information and/or exchange data with the deduplication engine 226.

The deduplication engine 226 may include a CPU or the like. The deduplication engine 226 may be configured to track data content of memory blocks, as described herein. The deduplication engine 226 may also be configured to resolve logical addresses to physical addresses. The deduplication engine 226 may be communicatively coupled to the CAM 227, the local memory 228, and the block allocators 229. The block allocators 229 may control the allocation and freeing (e.g., releasing) of memory blocks for the memory device 230. In an allocation operation, a block allocator 229 may return the address of a block that can be written to freely, which may be used when a write of a unique block is requested by a user. In a free operation, a block allocator 229 may mark a block as being not required anymore so that the block can be used for new data, which may be used when a unique block is overwritten with duplicated content, so that the block's memory location can be used for other purposes. The central controller 224 may include one block allocator 229 per memory bank of the memory device 230 (e.g., to provide improved performance), and the block allocators 229 may be accessed in a round-robin manner.

The memory device 230 (e.g., DRAM) may include volatile memory 232 (e.g., for user data), a pointers data structure 234 (e.g., a table), a reference counters data structure 236 (e.g., a table), and one or more free block bitmap components 238. In some implementations, the volatile memory 232 may correspond to one or more memory arrays 130. The pointers data structure 234 may indicate a mapping of logical addresses to physical addresses of the volatile memory 232. The reference counters data structure 236 may indicate respective reference counters for respective physical addresses of the volatile memory 232, as described herein. The memory device 230 may include one free block bitmap component 238 per memory bank of the memory device 230. A free block bitmap component 238 may provide tracking of free blocks and used blocks of the volatile memory 232. In some implementations, the pointers data structure and/or the reference counters data structure may be cached in the central controller 224 to provide improved performance.

The number and arrangement of components shown in FIG. 3 are provided as an example. In practice, there may be additional components, fewer components, different components, or differently arranged components than those shown in FIG. 3. Furthermore, two or more components shown in FIG. 3 may be implemented within a single component, or a single component shown in FIG. 3 may be implemented as multiple, distributed components. Additionally, or alternatively, a set of components (e.g., one or more components) shown in FIG. 3 may perform one or more operations described as being performed by another set of components shown in FIG. 3.

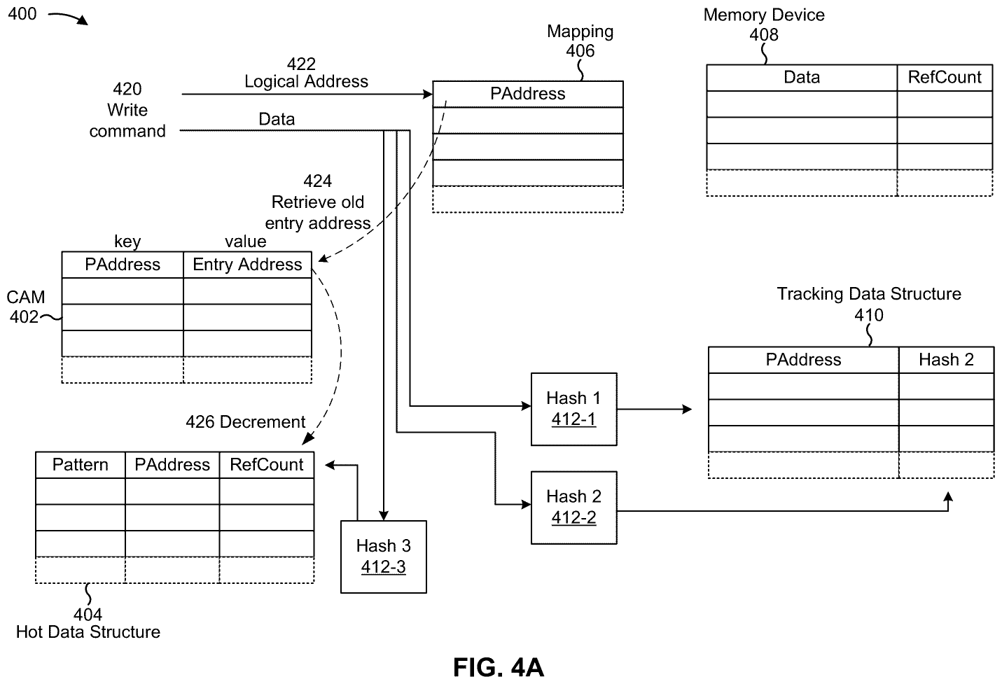

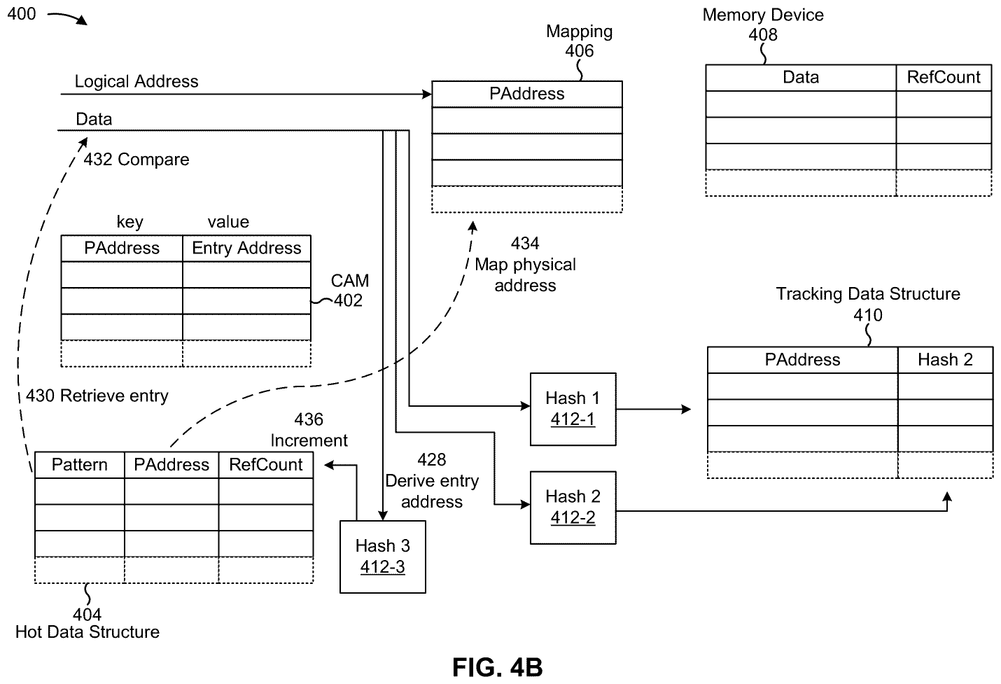

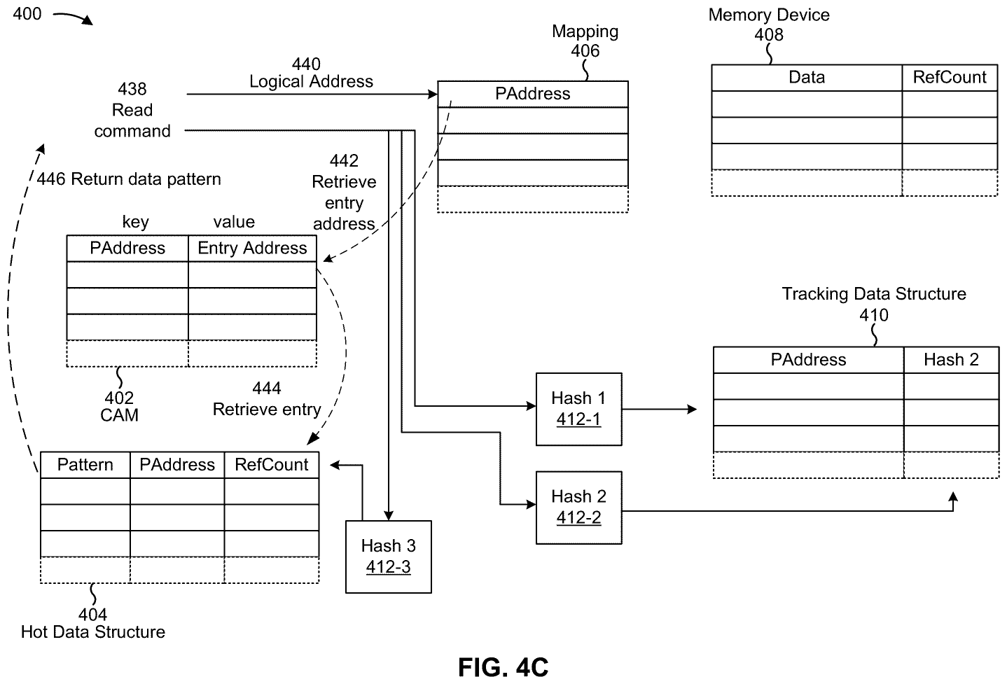

FIG. 4A-4C are diagrams of an example 400 of online deduplication for volatile memory. The operations described in connection with FIGS. 4A-4C may be performed by the memory system 215 and/or one or more components of the memory system 215, such as the CXL controller 220 and/or the central controller 224 (e.g., the deduplication engine 226). Additionally, or alternatively, the operations described in connection with FIGS. 4A-4C may be performed by the memory system 110 and/or one or more components of the memory system 110, such as the memory system controller 115, one or more memory devices 120, and/or one or more local controllers 125. As one example, the description to follow describes the operations as being performed by a controller (e.g., the CXL controller 220 and/or the central controller 224).

As shown, the example 400 includes a CAM 402, a data structure 404, a mapping 406, a memory device 408, a data structure 410, and hashing components 412-1, 412-2, and 412-3. The CAM 402 may correspond to the CAM 227 of the central controller 224. In some implementations, the CAM 402 may be another type of memory, such as RAM. The data structure 404 may be in the local memory 228 of the central controller 224. The data structure 404 may be referred to herein as the “hot data structure 404.” The mapping 406 may correspond to one or more pointers data structures 234. The memory device 408 may correspond to the memory device 230. The data structure 410 may be in the local memory 228 of the central controller 224. The data structure 410 may be referred to herein as the “tracking data structure 410.” The hashing components 412 may be implemented by the central controller 224.

The memory device 408 may include volatile memory (shown as “Data”) and a reference counters data structure (shown as “RefCount”). The volatile memory of the memory device 408 may correspond to the volatile memory 232. For example, the volatile memory may be DRAM. The reference counters data structure may correspond to the reference counters data structure 236. The volatile memory may include a plurality of memory locations (e.g., blocks) and each memory location may be associated with a physical address. For example, a physical address may indicate a physical location in the volatile memory, such as a block where data can be stored. Each physical address may be associated with a reference counter that indicates a quantity of logical addresses mapped to the physical address (e.g., in connection with deduplication).

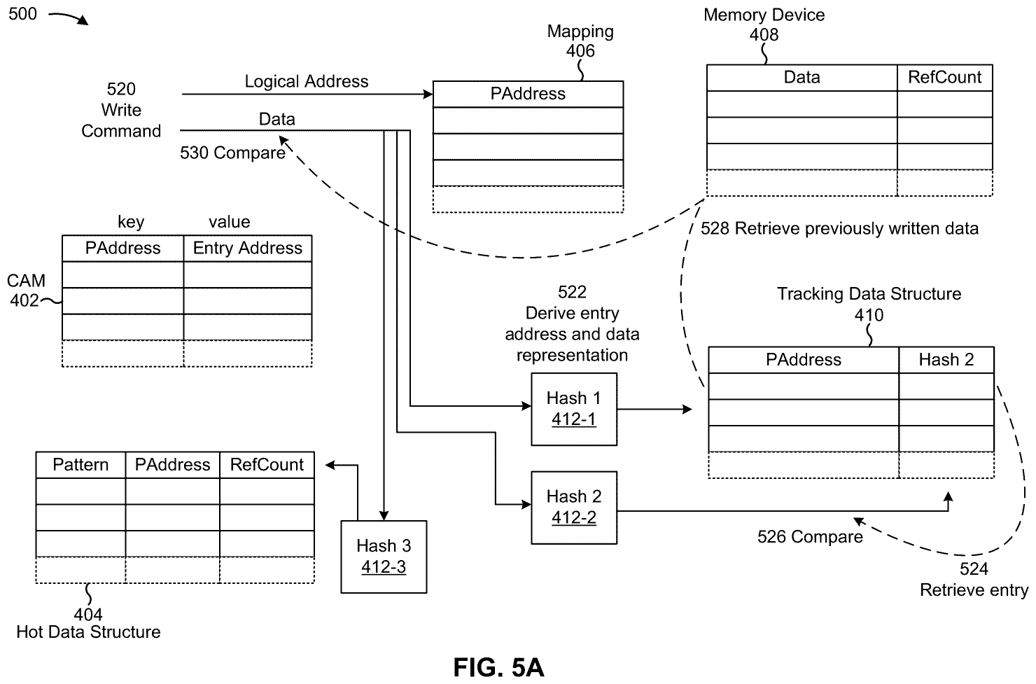

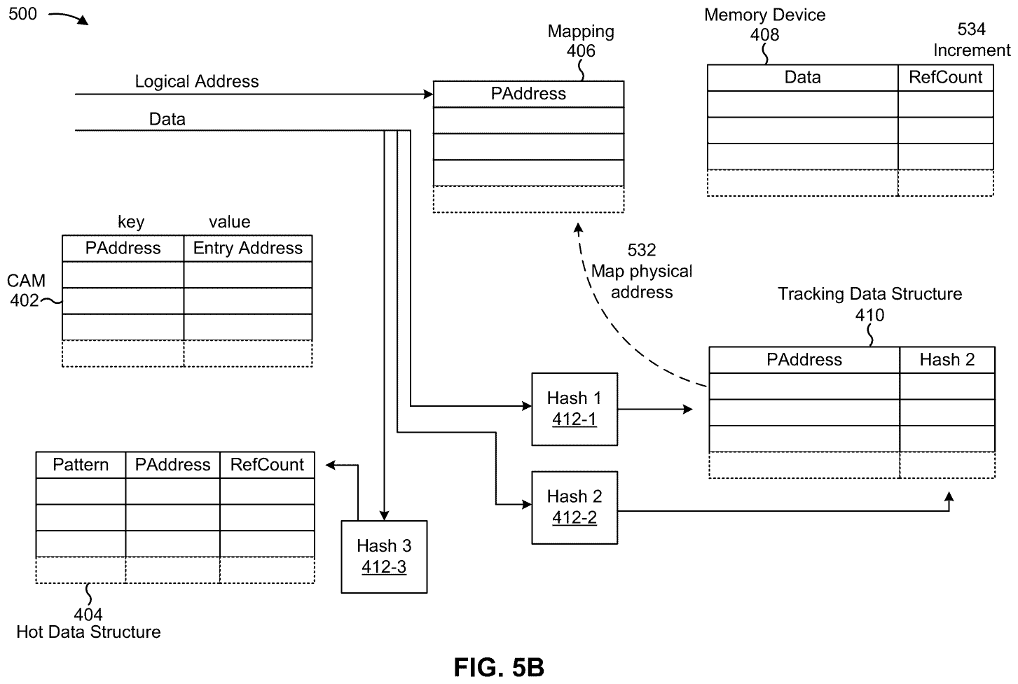

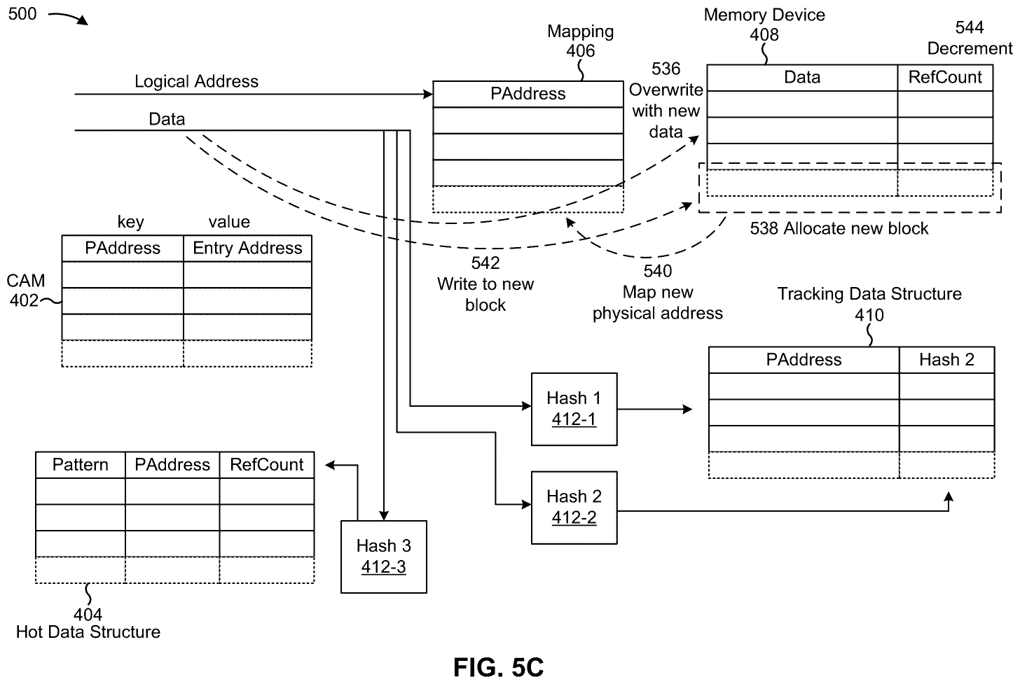

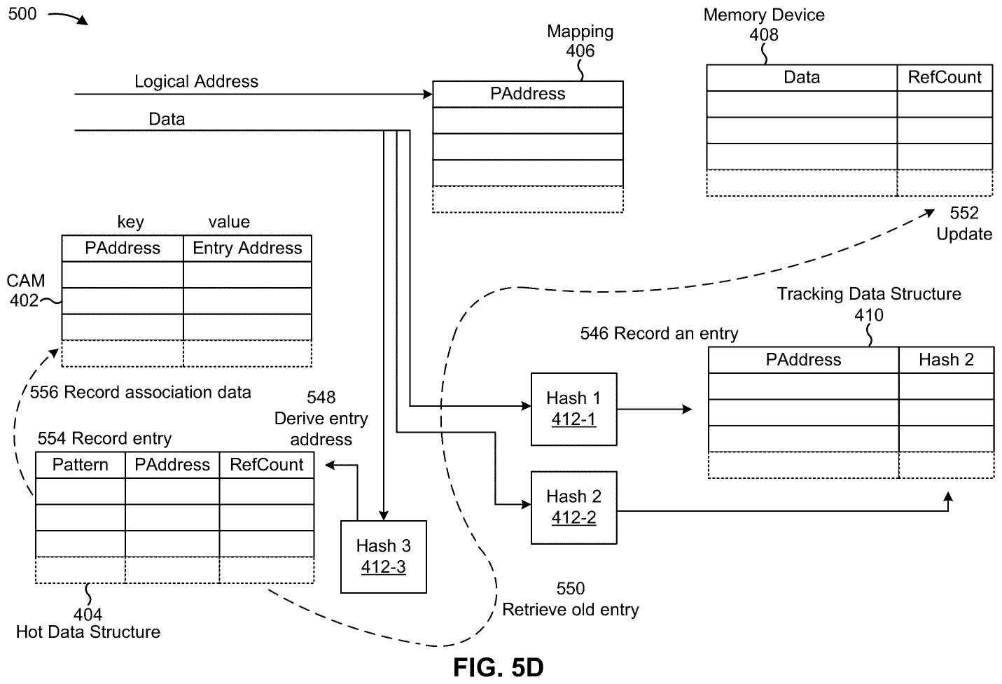

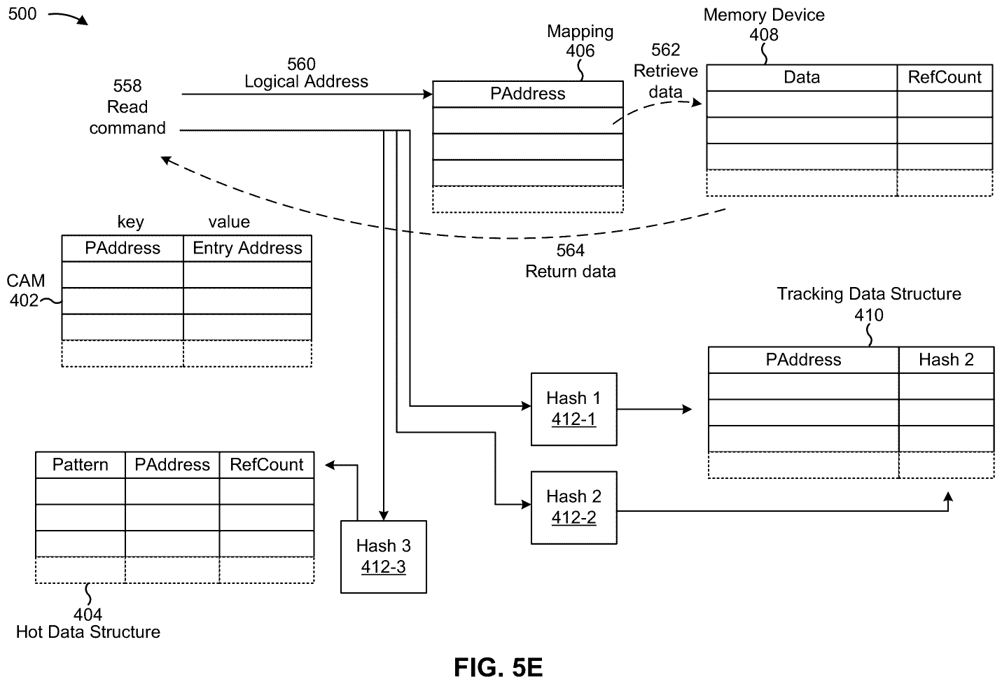

The CAM 402 and the hot data structure 404 may be used for read and write operations relating to frequently-occurring data patterns (e.g., a block of all 0 bits or a block of all 1 bits), which can be referred to as “hot data patterns.” Because these hot data patterns are frequently occurring, using the CAM 402 and the hot data structure 404, which can be implemented in the local memory 228 of the central controller 224 (e.g., closer to the central controller 224), improves a speed at which read operations and write operations can be performed. However, in some implementations, the CAM 402 and the hot data structure 404 may not be used for deduplication operations, as described in connection with FIGS. 5A-5E.

The CAM 402 may store associations between physical addresses of the volatile memory and entry addresses for entries in the hot data structure 404 (e.g., as key-value pairs). The hot data structure 404 may store one or more entries. Each entry may be associated with an entry address. Each entry may indicate a duplicate data pattern (shown as a “Pattern” field) representing previously written data to the volatile memory, a physical address (shown as a “PAddress” field) of the volatile memory that contains the previously written data, and a reference counter (shown as a “RefCount” field) indicating a quantity of logical addresses that are mapped to the physical address (e.g., in connection with deduplication).

The mapping 406 may indicate a mapping of logical memory addresses (sometimes referred to as logical addresses) to physical memory addresses (sometimes referred to as physical addresses). For example, a physical address written to a location of the mapping 406 addressed by a logical address indicates that the physical address is mapped to the logical address. The tracking data structure 410 may store one or more entries. Each entry may be associated with an entry address. Each entry may indicate a physical address (shown as a “PAddress” field) of the volatile memory that contains previously written data and a stored data representation of the previously written data (e.g., a hash value of the previously written data).

Each of the hashing components 412 may convert input data to a hash value using a hashing function. For example, the first hashing component 412-1 may use a first hashing function, the second hashing component 412-2 may use a second hashing function, and the third hashing component 412-3 may use a third hashing function. The hashing functions may be non-cryptographic hashing functions, such as cyclic redundancy checks (CRCs). The first hashing component 412-1 may be configured to convert data associated with a write command to a hash value used as an entry address of an entry of the tracking data structure 410 (e.g., the entry address is used as an index of the tracking data structure 410). The second hashing component 412-2 may be configured to convert data associated with a write command to a hash value used as a data representation in the tracking data structure 410. The third hashing component 412-3 may be configured to convert data associated with a write command to a hash value used as an entry address of an entry of the hot data structure 404 (e.g., the entry address is used as an index of the hot data structure 404). A hash value derived from data associated with a write command may be smaller than the data itself, thereby allowing for tracking of the data with a reduced storage burden.

In a write operation, as shown in FIG. 4A, and by reference number 420, the controller may receive a command to write new data to the volatile memory. The command may be from a host device (e.g., host device 210). The command may indicate a logical address associated with the new data (e.g., the logical address to which the new data is to be written).

As shown by reference number 422, the controller may obtain an old physical address (e.g., of the volatile memory) that is currently mapped to the logical address by the mapping 406. For example, the controller may translate the logical address to the old physical address using the mapping 406. Previously written data (e.g., different than the new data of the write command) may already be stored at the old physical address mapped to the logical address. Accordingly, before the logical address can be used in connection with the write command, the controller may perform various housekeeping operations with respect to the old physical address, as described in connection with reference numbers 424 and 426.

As shown by reference number 424, the controller may retrieve, from the CAM 402, an old entry address associated with the old physical address. For example, the controller may search the CAM 402 using the old physical address, and may retrieve the old entry address if present in the CAM 402. The old entry address may point to an old entry in the hot data structure 404. The old entry may indicate a duplicate data pattern (e.g., used for deduplication) representing the previously written data to the volatile memory, the old physical address of the volatile memory for the previously written data, and a reference counter indicating a quantity of logical addresses mapped to the old physical address.

As shown by reference number 426, the controller may decrement the reference counter for the old entry in the hot data structure 404. For example, because the logical address will no longer have an association with the old physical address (e.g., once the write command is executed), the reference counter may be decremented to indicate that one less logical address is associated with the old physical address. The controller may decrement the reference counter using a read-modify-write operation.

After the housekeeping operations with respect to the old physical address are completed, the logical address can then be used for the new data of the write command. However, rather than simply writing the new data to the volatile memory, the controller may perform a deduplication operation to check if the logical address can be mapped to a physical address already in use and without allocating a new block of the volatile memory for the new data.

As shown in FIG. 4B, and by reference number 428, the controller may derive an entry address of the hot data structure 404, using the new data of the write command. For example, the controller may convert the new data to the entry address using the third hashing function (e.g., using the third hashing component 412-3). As shown by reference number 430, the controller may retrieve, from the hot data structure 404, an entry associated with the entry address (e.g., if such an entry is present). In a similar manner as described above, the entry may indicate a duplicate data pattern (e.g., used for deduplication) representing previously written data to the volatile memory, a physical address of the volatile memory for the previously written data, and a reference counter indicating a quantity of logical addresses mapped to the physical address. The duplicate data pattern can be used to identify duplicate data. Thus, the controller may retrieve a duplicate data pattern using information in a local memory of the controller (e.g., the information in the hot data structure 404).

As shown by reference number 432, the controller may compare the new data to the duplicate data pattern to identify whether the new data matches (e.g., is a duplicate of) the duplicate data pattern. For example, the new data matching the duplicate data pattern indicates that the new data can be deduplicated (e.g., not written to the volatile memory).

Accordingly, responsive to the new data matching the duplicate data pattern (e.g., the current write operation uses a hot data pattern), as shown by reference number 434, the controller may map the physical address (e.g., that is indicated by the entry) associated with the data pattern to the logical address (e.g., the physical address may be written to a location of the mapping 406 addressed by the logical address), without writing the new data to the volatile memory. Thus, duplicated data (e.g., duplicated blocks) may be associated with the same physical address but different logical addresses. By mapping the physical address to the logical address, subsequent read commands for the logical address will return the correct data (e.g., will return the duplicate data pattern, which is a duplicate of the new data of the write command) even though no data was actually written to the volatile memory in connection with the write command, thereby conserving significant memory resources.

In addition, responsive to the new data matching the duplicate data pattern, as shown by reference number 436, the controller may increment the reference counter of the entry in the hot data structure 404 (e.g., using a read-modify-write operation). Incrementing the reference counter indicates that one additional logical address is now mapped to the physical address. In some implementations, the controller may decrement a reference counter associated with an old physical address, in the volatile memory, that was mapped to the logical address before the re-mapping described at reference number 434 (e.g., using a read-modify-write operation). If the reference counter associated with the old physical address has a value of 1, then the controller may cause the old physical address to be freed (e.g., because there are no longer any logical addresses mapped to the old physical address).

In a read operation, as shown in FIG. 4C, and by reference number 438, the controller may receive a command to read data from the volatile memory. The command may be from a host device (e.g., host device 210). The command may indicate a logical address associated with the data (e.g., the logical address that contains the data to be read). As shown by reference number 440, the controller may obtain a physical address (e.g., of the volatile memory) that is mapped to the logical address by the mapping 406, in a similar manner as described above. As shown by reference number 442, the controller may retrieve, from the CAM 402, an entry address associated with the physical address, in a similar manner as described above. The entry address may point to an entry in the hot data structure 404.

As shown by reference number 444, the controller may retrieve from the hot data structure 404, the entry for the entry address. The entry may indicate a data pattern (e.g., a duplicate data pattern) representing previously written data to the volatile memory, the physical address of the volatile memory for the previously written data, and a reference counter indicating a quantity of logical addresses mapped to the physical address, in a similar manner as described herein. Accordingly, the data pattern is responsive to the read command (e.g., the data requested by the read command is a duplicate of the data pattern), and the read operation can be performed without retrieving the data from the volatile memory (e.g., which is slower than retrieving the data pattern from the hot data structure 404). As shown by reference number 446, the controller may return (e.g., output), to the host device, the data pattern in response to the read command.

As indicated above, FIGS. 4A-4C are provided as an example. Other examples may differ from what is described with regard to FIGS. 4A-4C.

FIGS. 5A-5E are diagrams of an example 500 of online deduplication for volatile memory. The operations described in connection with FIGS. 5A-5E may be performed by the memory system 215 and/or one or more components of the memory system 215, such as the CXL controller 220 and/or the central controller 224 (e.g., the deduplication engine 226). Additionally, or alternatively, the operations described in connection with FIGS. 5A-5E may be performed by the memory system 110 and/or one or more components of the memory system 110, such as the memory system controller 115, one or more memory devices 120, and/or one or more local controllers 125. As one example, the description to follow describes the operations as being performed by a controller (e.g., the CXL controller 220 and/or the central controller 224).

As shown, the example 500 includes the mapping 406, the memory device 408, the tracking data structure 410, and the hashing components 412-1 and 412-2, as described in connection with FIGS. 4A-4C. In some implementations, the CAM 402 and the hot data structure 404 may not be used for deduplication operations. For example, while the CAM 402 and the hot data structure 404 may improve performance through the use of hot data patterns, in some implementations, the CAM 402 and the hot data structure 404 may not be used, in order to reduce complexity. As another example, referring back to reference number 432 of FIG. 4B, the CAM 402 and the hot data structure 404 may not be used in a deduplication operation when the data pattern (e.g., in the entry of the hot data structure 404) does not match the new data of the write command (e.g., the new data of the write command is not a hot pattern).

In a write operation, as shown in FIG. 5A, and by reference number 520, the controller may receive a command to write new data to the volatile memory, in a similar manner as described in connection with FIGS. 4A-4C. For example, the command may indicate a logical address associated with the new data. In some implementations, if hot data patterns are being used, the controller may perform the operations described at reference numbers 428, 430, and 432 of FIG. 4B to obtain an entry from the hot data structure 404. If the entry indicates a duplicate data pattern that does not match the new data of the write command, then the controller may perform a deduplication operation differently from the description in FIGS. 4A-4C. Similarly, if hot data patterns are not being used (e.g., the CAM 402 and the hot data structure 404 are eliminated), then the controller may perform a deduplication operation differently from the description in FIGS. 4A-4C.

As shown by reference number 522, the controller may derive an entry address, of the tracking data structure 410, using the new data of the write command. For example, the controller may convert the new data to the entry address using the first hashing function (e.g., using the first hashing component 412-1). In some implementations, the controller may also derive a data representation of the new data. For example, the controller may convert the new data to the data representation using the second hashing function (e.g., using second hashing component 412-2). In some cases, the first hashing function may produce collisions, whereby the first hashing function may output the same entry address of the tracking data structure 410 for different input data (e.g., because output hash values produced by the first hashing function are smaller than the input data). Accordingly, data representations produced by the second hashing function can resolve collisions by providing secondary hash values for the input data (e.g., the likelihood that different input data would generate the same entry address and the same data representation is small).

As shown by reference number 524, the controller may retrieve, from the tracking data structure 410, an entry associated with the entry address (e.g., if such an entry is present). The entry may indicate a physical address of the volatile memory, containing previously written data, and a stored data representation that was derived using the second hashing function on the previously written data. As shown by reference number 526, the controller may compare the data representation and the stored data representation to identify whether the data representation matches the stored data representation. For example, the data representation not matching the stored data representation may indicate that the new data and the previously written data at the physical location are not duplicates (e.g., the first hashing function produced a collision). Alternatively, the data representation matching the stored data representation may indicate that the new data and the previously written data at the physical address are likely to be duplicates.

As shown by reference number 528, responsive to the data representation matching the stored data representation, the controller may retrieve the previously written data from the physical address of the volatile memory. The previously written data is a duplicate data pattern because the previously written data can be used to identify duplicate data. Thus, the controller may retrieve a duplicate data pattern using information in a local memory of the controller (e.g., the information in the tracking data structure 410). The physical address may be associated with a reference counter indicating a quantity of logical addresses mapped to the physical address.

As shown by reference number 530, the controller may compare the new data of the write command to the previously written data (i.e., the duplicate data pattern) to identify whether the new data matches (e.g., is a duplicate of) the previously written data. For example, the new data matching the previously written data indicates that the new data can be deduplicated (e.g., not written to the volatile memory).

Accordingly, responsive to the new data matching the previously written data (e.g., the new data is a duplicated write pattern), as shown in FIG. 5B, and by reference number 532, the controller may map the physical address (e.g., that is indicated by the entry) associated with the previously written data to the logical address (e.g., the physical address may be written to a location of the mapping 406 addressed by the logical address), without writing the data to the volatile memory. Thus, duplicated data (e.g., duplicated blocks) may be associated with the same physical address but different logical addresses. By mapping the physical address to the logical address, subsequent read commands for the logical address will return the correct data (e.g., will return the previously written data, which is a duplicate of the new data for the write command) even though no data was actually written to the volatile memory in connection with the write command, thereby conserving significant memory resources.

In addition, responsive to the new data matching the previously written data, as shown by reference number 534, the controller may increment the reference counter associated with the physical address in the volatile memory (e.g., using a read-modify-write operation). Incrementing the reference counter indicates that one additional logical address is now mapped to the physical address. In some implementations, the controller may decrement a reference counter associated with an old physical address, in the volatile memory, that was mapped to the logical address before the re-mapping described at reference number 532 (e.g., using a read-modify-write operation). If the reference counter associated with the old physical address has a value of 1, then the controller may cause the old physical address to be freed (e.g., because there are no longer any logical addresses mapped to the old physical address).

The data representation not matching the stored data representation and/or the new data not matching the previously written data in the volatile memory may indicate that the new data of the write command is not a duplicate. Accordingly, responsive to the data representation not matching the stored data representation and/or the new data not matching the previously written data (and/or responsive to an entry address based on the new data not being present in the hot data structure 404 and/or the tracking data structure 410), the controller may cause the new data to be written to the volatile memory. As shown in FIG. 5C, and by reference number 536, if the reference counter associated with the physical address for the previously written data has a value of 1, then the previously written data at the physical address may be overwritten with the new data of the write command. As shown by reference number 538, if there is no corresponding data for the logical address in the volatile memory (e.g., the logical address previously pointed to the CAM 402 and the hot data structure 404) or if the reference counter associated with the physical address for the previously written data has a value greater than 1, then the controller may cause a new block to be allocated in the volatile memory. Furthermore, the controller may map a new physical address of the new block to the logical address (e.g., the new physical address may be written to a location of the mapping 406 addressed by the logical address), as shown by reference number 540, and the controller may cause the new data of the write command to be written to the new physical address of the new block, as shown by reference number 542. Moreover, as shown by reference number 544, if the reference counter associated with the physical address for the previously written data has a value greater than 1, then the controller may decrement the reference counter (e.g., using a read-modify-write operation). For example, because the logical address will no longer have an association with the physical address (e.g., once the write command is executed), the reference counter may be decremented to indicate that one less logical address is associated with the physical address.

In some implementations, if the new data of the write command was written to the volatile memory (e.g., the new data is not a duplicate), tracking of the new data may be initiated to enable subsequent write commands to check for duplicates against the new data of the current write command. For example, tracking the new data may be initiated responsive to one or more conditions (e.g., metrics) being satisfied (e.g., which can be assessed during a write operation). As an example, a condition may be that the new data has low (e.g., not exceeding a threshold) data entropy (e.g., the new data is all 0 bits or all 1 bits). As another example, a condition may be that other data that is currently being tracked is associated with a low (e.g., not exceeding a threshold) reference count (e.g., the other data is not duplicated often). As shown in FIG. 5D, and by reference number 546, to initiate tracking of the new data, the controller may record, in the tracking data structure 410, an entry indicating the physical address in the volatile memory to which the new data was written and a stored data representation of the new data (e.g., derived using the second hashing function on the new data). The entry may be recorded in the tracking data structure 410 at an entry address derived using the new data (e.g., derived using the first hashing function on the new data). In some examples, recording the entry at the entry address may overwrite a previous entry at the entry address.

In some implementations, the new data of the write command may be promoted to a hot data pattern. For example, the new data may be promoted to a hot data pattern responsive to one or more conditions (e.g., metrics) being satisfied (e.g., which can be assessed during a write operation). As an example, a condition may be that the physical address in the volatile memory containing the new data is associated with a high (e.g., meeting a threshold) reference count. As another example, a condition may be that a data pattern (that represents the new data and duplicates thereof) has been involved in a high (e.g., meeting a threshold) number of read operations and/or write operations. Before promoting the new data to a hot data pattern, the controller may perform various housekeeping operations to preserve a reference counter for an old data pattern that will be overwritten, as described in connection with reference numbers 548-552.

As shown by reference number 548, the controller may derive an entry address, of the hot data structure 404, using the new data of the write command (e.g., using the third hashing function), as described herein. As shown by reference number 550, the controller may retrieve, from the hot data structure 404, an old entry at the entry address. The old entry may indicate the old data pattern, an old physical address in the volatile memory associated with the old data pattern, and an old reference counter associated with the old data pattern. As shown by reference number 552, the controller may update, in the volatile memory, a reference counter associated with the old physical address to a value of the old reference counter.

After the housekeeping operations with respect to the old data pattern are completed, the new data can then be promoted to a hot data pattern. As shown by reference number 554, the controller may record, in the hot data structure 404, an entry indicating the physical address in the volatile memory containing the new data and a duplicate data pattern representing the new data (e.g., the duplicate data pattern is the same as the new data). The entry may be recorded in the hot data structure 404 at an entry address derived using the new data (e.g., derived using the first hashing function on the new data). In some examples, recording the entry at the entry address may overwrite the old entry at the entry address. As shown by reference number 556, the controller may record, in the CAM 402 (shown in FIG. 4), association data (e.g., a key-value pair) indicating an association between the physical address in the volatile memory containing the new data and the entry address.

In a read operation, as shown in FIG. 5E, and by reference number 558, the controller may receive a command to read data from the volatile memory. The command may be from a host device (e.g., host device 210). The command may indicate a logical address associated with the data (e.g., the logical address that contains the data to be read). As shown by reference number 560, the controller may obtain a physical address (e.g., of the volatile memory) that is mapped to the logical address by the mapping 406, in a similar manner as described above. As shown by reference number 562, the controller may retrieve duplicate data (e.g., if the data requested by the read command was deduplicated) from the physical address of the volatile memory. For example, the controller may retrieve the duplicate data from the physical address of the volatile memory if the physical address is not indexed in the CAM 402 (e.g., thereby indicating that the data to be read is not a hot data pattern). As shown by reference number 564, the controller may return (e.g., output), to the host device, the duplicate data in response to the read command.

As indicated above, FIGS. 5A-5E are provided as an example. Other examples may differ from what is described with regard to FIGS. 5A-5E.

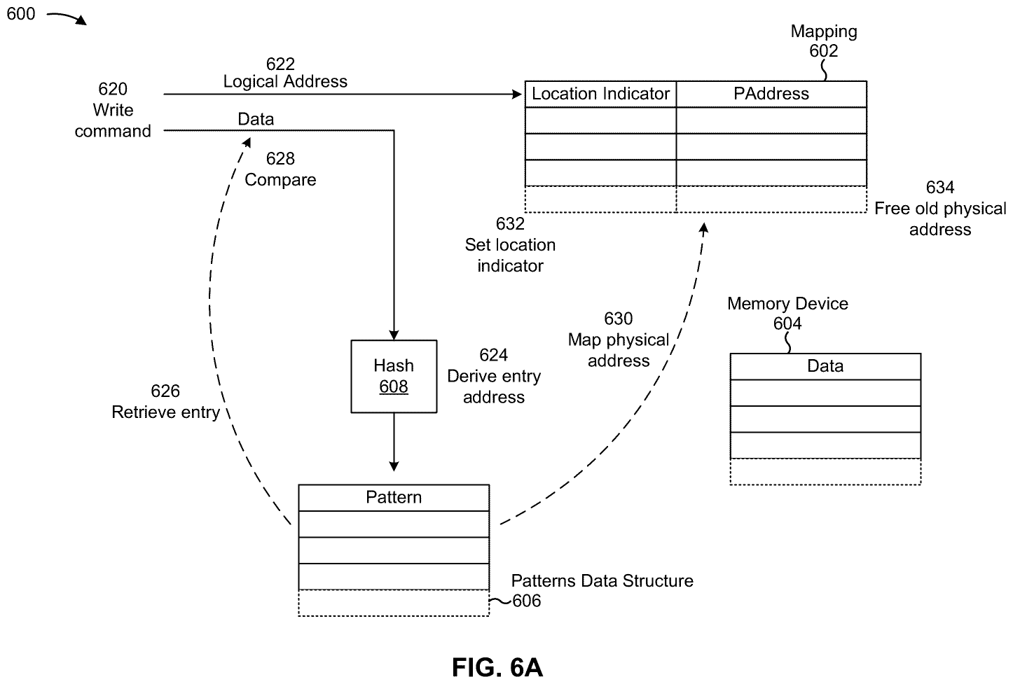

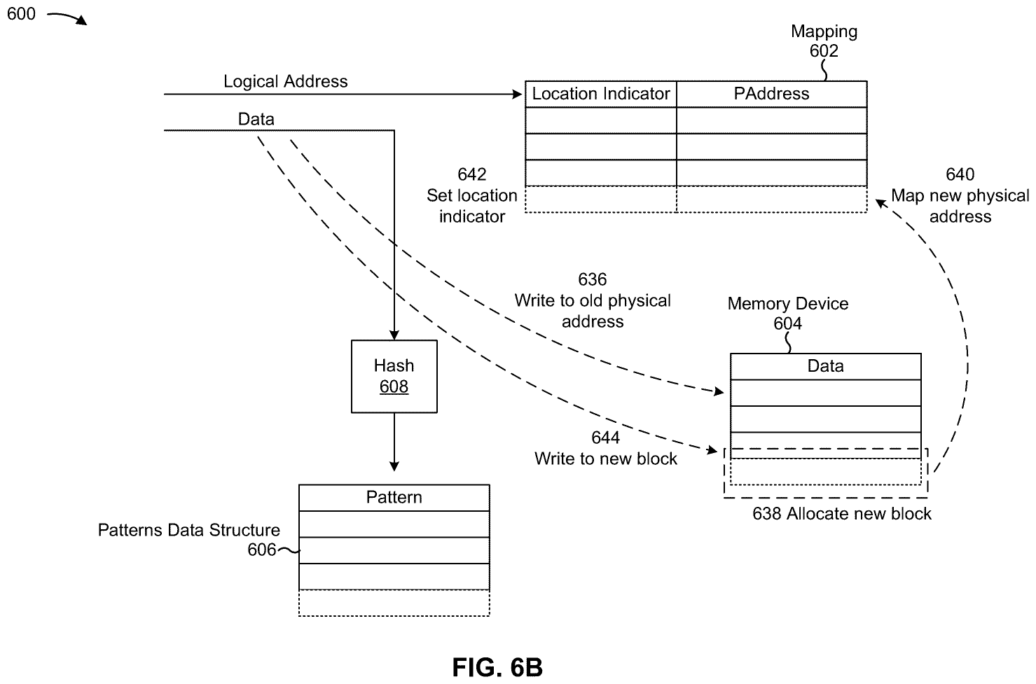

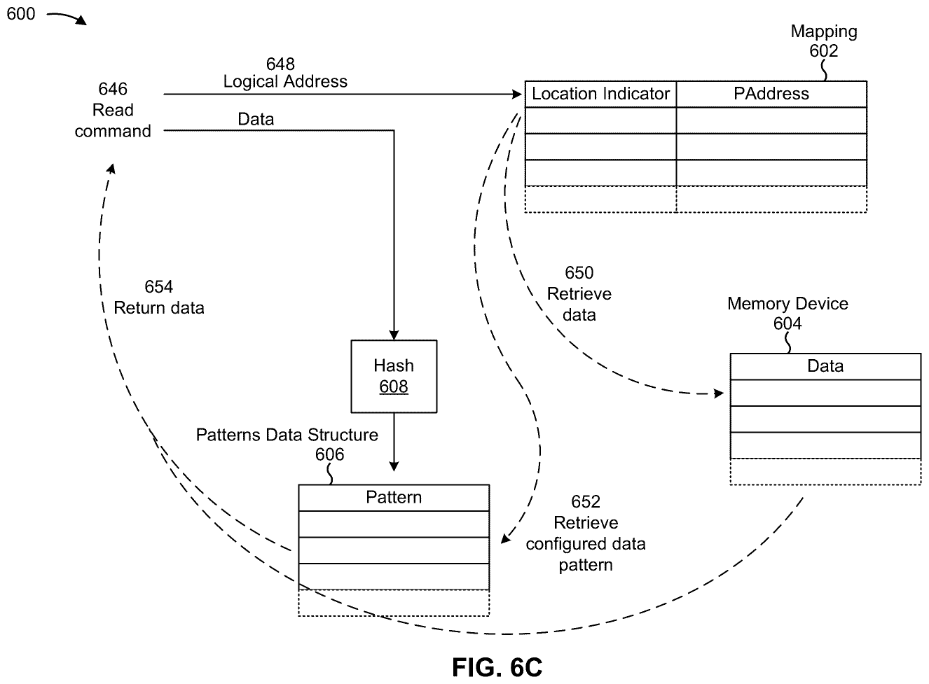

FIGS. 6A-6C are diagrams of an example 600 of online deduplication for volatile memory. The operations described in connection with FIGS. 6A-6C may be performed by the memory system 215 and/or one or more components of the memory system 215, such as the CXL controller 220 and/or the central controller 224 (e.g., the deduplication engine 226). Additionally, or alternatively, the operations described in connection with FIGS. 6A-6C may be performed by the memory system 110 and/or one or more components of the memory system 110, such as the memory system controller 115, one or more memory devices 120, and/or one or more local controllers 125. As one example, the description to follow describes the operations as being performed by a controller (e.g., the CXL controller 220 and/or the central controller 224).

As shown, the example 600 includes a mapping 602, a memory device 604, a data structure 606, and a hashing component 608. The mapping 602 may correspond to one or more pointers data structures 234. The memory device 604 may correspond to the memory device 230. The data structure 606 may be in the local memory 228 of the central controller 224. The data structure 606 may be referred to herein as the “patterns data structure 606.” The hashing component 608 may be implemented by the central controller 224.

The memory device 604 may include volatile memory (shown as “Data”), in a similar manner as the memory device 408. The volatile memory of the memory device 604 may correspond to the volatile memory 232. For example, the volatile memory may be DRAM. The volatile memory may include a plurality of memory locations (e.g., blocks) and each memory location may be associated with a physical address. For example, a physical address may indicate a physical location in the volatile memory, such as a block where data can be stored. The memory device 604 may not include a reference counter data structure, as described in connection with FIGS. 4A-4C and 5A-5E.

The mapping 602 may indicate a mapping of logical addresses to physical addresses, in a similar manner as the mapping 406. For example, a physical address written to a location of the mapping 602 addressed by a logical address indicates that the physical address is mapped to the logical address. In some implementations, the mapping 602 may indicate, for each respective physical address, whether the respective physical address is for the volatile memory or the patterns data structure 606 using a location indicator (e.g., a single bit per physical address).

The patterns data structure 606 may store one or more entries. Each entry may be associated with an entry address. Each entry may indicate a duplicate data pattern (shown as a “Pattern” field). The duplicate data patterns of the patterns data structure 606 may be configured (e.g., fixed) data patterns. By using configured data patterns, the reference counters described in connection with FIGS. 4A-4C and 5A-5E can be eliminated, thereby simplifying deduplication operations and consuming less processor and/or memory resources. The configured data patterns may be loaded in the patterns data structure 606 at boot time by firmware of the controller. Additionally, or alternatively, the configured data patterns may be provided by an end-user (e.g., through particular commands) over an out-of-band channel. The configured data patterns may be data patterns that have a high likelihood of being duplicated (e.g., a block of all 0 bits or a block of all 1 bits).

The hashing component 608 may convert input data to a hash value using a hashing function (e.g., the first hashing function described in FIGS. 4 and 5), in a similar manner as described above. The hashing component 608 may be configured to convert data associated with a write command to a hash value used as an entry address of an entry of the patterns data structure 606 (e.g., the entry address is used as an index of the patterns data structure 606).

In a write operation, as shown in FIG. 6A, and by reference number 620, the controller may receive a command to write new data to the volatile memory, in a similar manner as described in connection with FIGS. 4 and 5. For example, the command may indicate a logical address associated with the new data. As shown by reference number 622, the controller may obtain, using the mapping 602, an old physical address mapped to the logical address and a location indicator for the old physical address. The location indicator for the old physical address may indicate whether the old physical address is associated with the volatile memory or the patterns data structure 606.

As shown by reference number 624, the controller may derive an entry address, of the patterns data structure 606, using the new data of the write command. For example, the controller may convert the new data to the entry address using the hashing function (e.g., using the hashing component 608). The entry address may point to an entry in the patterns data structure 606.

As shown by reference number 626, the controller may retrieve, from the patterns data structure 606, the entry associated with the entry address (e.g., if such an entry is present). The entry may indicate a configured data pattern (i.e., a duplicate data pattern). The configured data pattern can be used to identify duplicate data. Thus, the controller may retrieve a duplicate data pattern using information in a local memory of the controller (e.g., the information in the patterns data structure 606).

As shown by reference number 628 the controller may compare the new data to the configured data pattern (i.e., the duplicate data pattern) to identify whether the new data matches (e.g., is a duplicate of) the configured data pattern. For example, the new data matching the configured data pattern indicates that the new data can be deduplicated (e.g., not written to the volatile memory).

Accordingly, responsive to the new data matching the configured data pattern, as shown by reference number 630, the controller may map a physical address associated with the configured data pattern (which in this case is the entry address) to the logical address (e.g., the entry address may be written to a location of the mapping 602 addressed by the logical address), without writing the new data to the volatile memory. By mapping the physical address to the logical address, subsequent read commands for the logical address will return the correct data (e.g., will return the configured data pattern, which is a duplicate of the new data for the write command) even though no data was actually written to the volatile memory in connection with the write command, thereby conserving significant memory resources.

In addition, responsive to the new data of the write command matching the configured data pattern, as shown by reference number 632, the controller may set the location indicator in the mapping 602, which is now associated with the physical address rather than the old physical address, to indicate that the physical address is associated with the patterns data structure 606. If, prior to the re-mapping described at reference number 632, the location indicator had been set to indicate that the old physical address was associated with the volatile memory, then as shown by reference number 634, the controller may cause the old physical address in the volatile memory to be freed (e.g., because the logical address will no longer have an association with the old physical address in the volatile memory).

Responsive to the new data not matching the configured data pattern (and/or responsive to an entry address based on the new data not being present in the patterns data structure 606), and if the location indicator is set to indicate that the old physical address is associated with the volatile memory, as shown in FIG. 6B, and by reference number 636, the controller may cause the new data of the write command to be written to the old physical address in the volatile memory. Conversely, responsive to the data not matching the configured data pattern, and if the location indicator is set to indicate that the old physical address is associated with the patterns data structure 606, as shown by reference number 638, the controller may cause a new block to be allocated in the volatile memory. Furthermore, the controller may map a new physical address of the new block to the logical address (e.g., the new physical address may be written to a location of the mapping 602 addressed by the logical address), as shown by reference number 640, the controller may set the location indicator for the new physical address to indicate that the new physical address is associated with the volatile memory, as shown by reference number 642, and the controller may cause the new data of the write command to be written to the new physical address of the new block, as shown by reference number 644.

In a read operation, as shown in FIG. 6C, and by reference number 646, the controller may receive a command to read data from the volatile memory. The command may be from a host device (e.g., host device 210). The command may indicate a logical address associated with the data (e.g., the logical address that contains the data to be read). As shown by reference number 648, the controller may obtain a physical address and a location indicator that is mapped to the logical address by the mapping 406, in a similar manner as described above.

If the location indicator indicates that the physical address is associated with the volatile memory, as shown by reference number 650, the controller may retrieve duplicate data (e.g., if the data requested by the read command was deduplicated) from the physical address of the volatile memory. If the location indicator indicates that the physical address is associated with the patterns data structure 606, as shown by reference number 652, the controller may retrieve the configured data pattern from the physical address (e.g., the entry address) of the patterns data structure 606. As shown by reference number 654, the controller may return (e.g., output), to the host device, the duplicate data or the configured data pattern (according to which one was retrieved) in response to the read command.

As indicated above, FIGS. 6A-6C are provided as an example. Other examples may differ from what is described with regard to FIGS. 6A-6C.

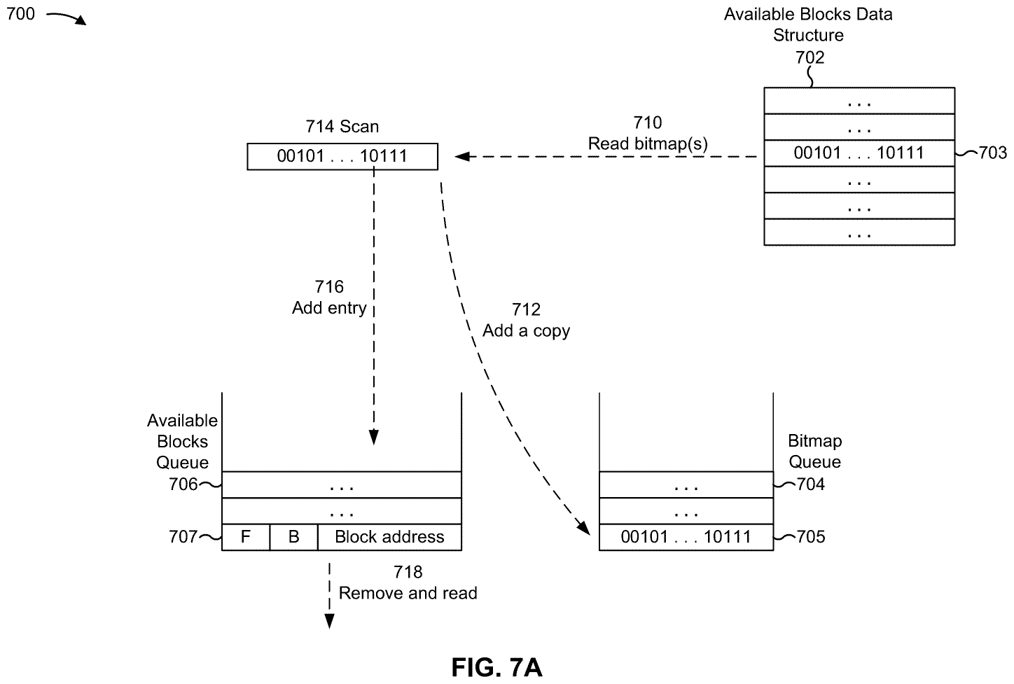

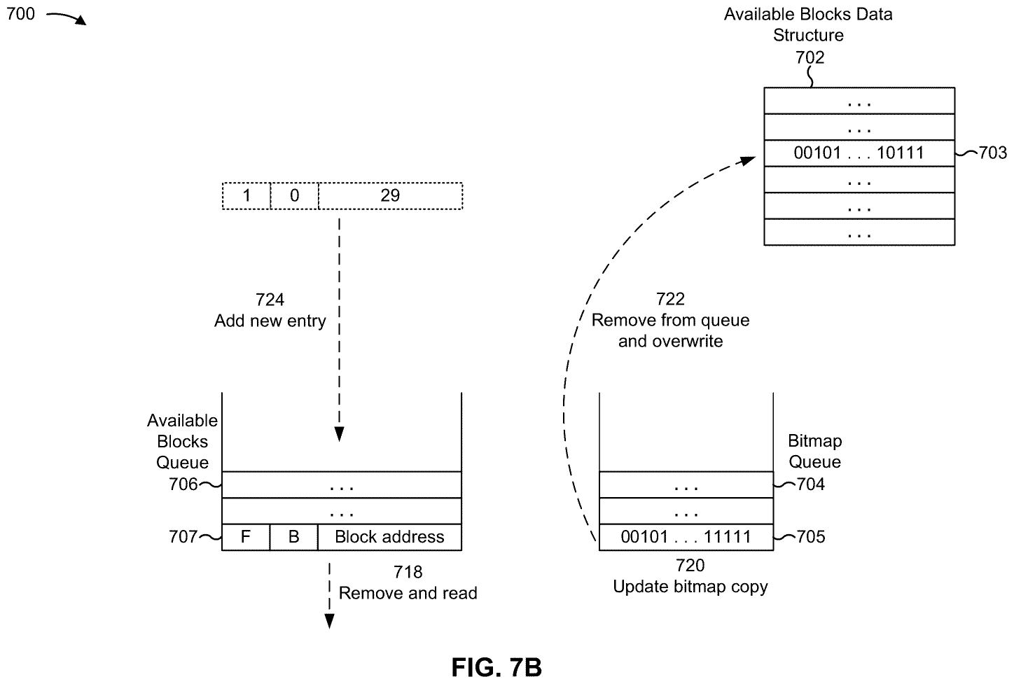

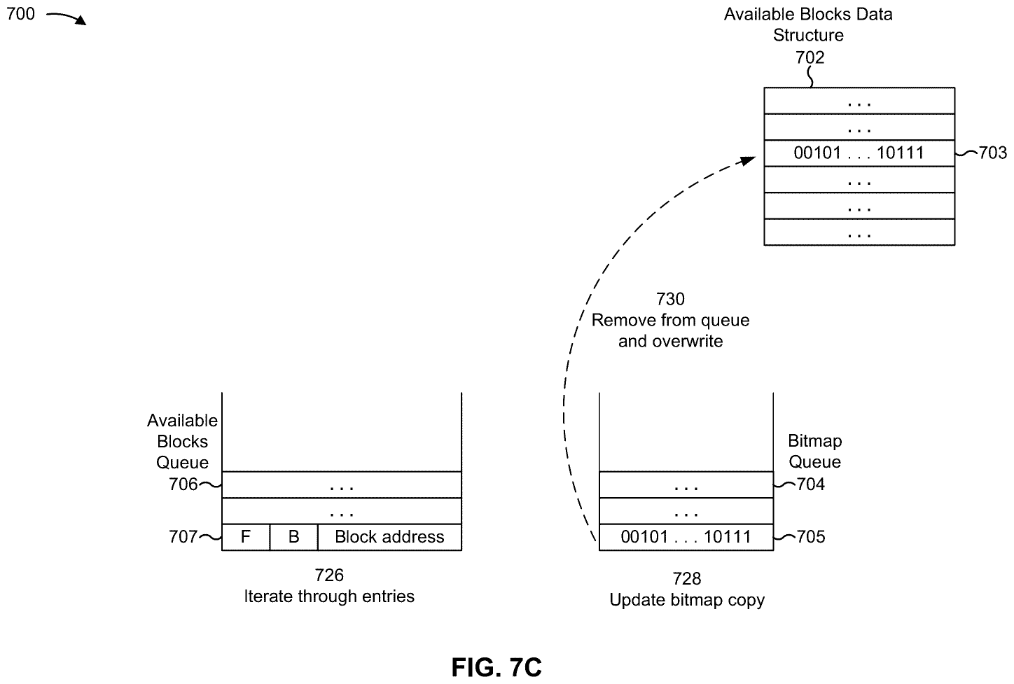

FIGS. 7A-7C are diagrams of an example 700 of block allocation. The techniques described in the example 700 can be used to identify the addresses of memory blocks (e.g., of volatile memory) that can be written to freely. Accordingly, these blocks can be allocated for writing in connection with the online deduplication for volatile memory described herein.

The operations described in connection with FIGS. 7A-7C may be performed by the memory system 215 and/or one or more components of the memory system 215, such as the CXL controller 220 and/or the central controller 224. Additionally, or alternatively, the operations described in connection with FIGS. 7A-7C may be performed by the memory system 110 and/or one or more components of the memory system 110, such as the memory system controller 115, one or more memory devices 120, and/or one or more local controllers 125. As one example, the description to follow describes the operations as being performed by a controller (e.g., the CXL controller 220 and/or the central controller 224). For example, the operations may be performed by the central controller 224 using the one or more block allocators 229.

As shown, the example 700 includes a data structure 702, a bitmap queue 704, and an available blocks queue 706. The data structure 702 may be implemented in a memory device, such as the memory device 230 (e.g., in the one or more free block bitmap components 238), the memory device 408, and/or the memory device 604, described herein. For example, the data structure 702 may correspond to a free block bitmap component 238 of the memory device 230. The data structure 702 may be referred to herein as the “available blocks data structure 702.” The available blocks data structure 702 may store a plurality of bitmaps 703 in respective entries. Each bit of a bitmap 703 corresponds to a respective block of the memory device and indicates whether that block is available (e.g., to be written to) or not available. In the example 700, a 0 bit is used to indicate that a block is free and a 1 bit is used to indicate that a block is occupied; however, the reverse may also be used in practice. The bitmaps 703 in the available blocks data structure 702 may represent memory blocks in sequence. For example, a bitmap 703 in a first entry of the available block data structure 702 may represent blocks for memory addresses 0 to 19, a bitmap 703 in a second entry of the available block data structure 702 may represent blocks for memory addresses 20 to 39, and so forth.

The bitmap queue 704 may include a data structure. The bitmap queue 704 may be implemented in the local memory 228 and/or a block allocator 229 of the central controller 224. The bitmap queue 704 may be used to track a state of bitmaps 703 read from the available blocks data structure 702. The available blocks queue 706 may include a data structure. The available blocks queue 706 may be implemented in the local memory 228 and/or a block allocator 229 of the central controller 224. The available blocks queue may be used to track the addresses of available memory blocks.

The controller may return addresses of one or more available blocks in response to a request for an available block from a requestor (e.g., the CXL controller 220, the central controller 224, or a memory controller 223). For example, the controller may receive the request for an available (e.g., free) block, and the controller may perform one or more block allocation operations, as described herein, to identify an available block in response to the request.

In some implementations, the controller may identify that a quantity of entries in the available blocks queue 706 is below a threshold, thereby indicating that the available blocks queue 706 should be replenished. To replenish the available blocks queue 706, as shown in FIG. 7A and by reference number 710, the controller may read one or more bitmaps 703 from the available blocks data structure 702. As shown by reference number 712, for each bitmap 703 that is read from the available blocks data structure 702, the controller may add a copy 705 of that bitmap as an entry in the bitmap queue 704. For example, the bitmap copy 705 may be added at the end of the bitmap queue 704.

As shown by reference number 714, for each bitmap 703 read from the available blocks data structure 702 and copied into the bitmap queue 704, the controller may scan the bitmap 703 to identify any available blocks indicated by the bitmap 703. For example, the controller may iterate through each bit of the bitmap 703 to identify any available blocks. If a bit of the bitmap 703 indicates that a block is occupied (e.g., the bit has a value of 1), then the controller may continue to the next bit. If a bit of the bitmap 703 indicates that a block is available (e.g., the bit has a value of 0), then as shown by reference number 716, the controller may add an entry 707 at an end of the available blocks queue 706 and then continue to the next bit.

The entry 707 recorded in the available blocks queue 706 may have multiple fields. A first field (shown as “Block address”) may indicate an address (e.g., a physical address) of the available block. The controller may identify the address in accordance with a position of the bit, corresponding to the available block, in the bitmap 703, and an entry location of the bitmap 703 in the available blocks data structure 702 (e.g., because the bitmaps 703 in the available blocks data structure 702 may represent memory address sequentially, as described herein).

A second field (shown as “B”), which can be referred to as a “boundary bit,” may indicate whether the bit is in an end position (e.g., a left-most position) of the bitmap 703. For example, a 0 bit may be used to indicate that the bit is not in the end position and a 1 bit may be used to indicate that the bit is in the end position; however, the reverse may also be used in practice. A third field (shown as “F”), which can be referred to as a “freed block bit,” may indicate whether the available block is available due to being released (e.g., by the requestor) or not due to being released (e.g., the available block was identified from a bitmap 703). For example, a 0 bit may be used to indicate that the block was not released and a 1 bit may be used to indicate that the block was released; however, the reverse may also be used in practice.

As shown in FIG. 7B, and by reference number 718, when a block is requested by the requestor, the controller may remove and read a first entry 707 from a front of the available blocks queue 706, and the controller may return (e.g., output) a block address indicated by the entry 707 as an available block. Accordingly, the available block will no longer be available. To indicate this, as shown by reference number 720, the controller may update (e.g., flip) a bit corresponding to the block in a first bitmap copy 705, at a front of the bitmaps queue 704, to indicate that the block is occupied. For each bitmap copy 705 (e.g., where the boundary bit of an entry 707 indicates whether a next entry 707 will represent a different bitmap), the order of the blocks in the available blocks queue 706 corresponds to the order of the 0s (zeros) in that bitmap copy 705. Accordingly, when a first block associated with a bitmap copy 705 is allocated, the controller may flip the first (e.g., right-most) 0 bit in the bitmap copy 705, when a second block associated with the bitmap copy 705 is allocated, the controller may flip the second 0 bit in the bitmap copy 705, and so forth.

As shown by reference number 722, once all of the bits in the first bitmap copy 705 indicate occupied blocks (e.g., the first bitmap copy 705 indicates a 1 value for every bit), the controller may remove the first bitmap copy 705 from the bitmap queue 704, and overwrite the corresponding bitmap 703 in the available blocks data structure 702 with the first bitmap copy 705. At times, the controller may receive an indication from the requestor that a block has been released. Here, as shown by reference number 724, the controller may add a new entry 707 at an end of the available blocks queue 706, in a similar manner as described above. In the new entry 707, the freed block bit may indicate that the block is available due to being released (e.g., the freed block bit may be set to 1 in the new entry 707).

In some implementations, the controller may identify that a quantity of entries in the available blocks queue 706 is above a threshold, thereby indicating that the available blocks queue 706 should be emptied. To empty (e.g., to reduce the quantity of entries in) the available blocks queue 706, as shown in FIG. 7C and by reference number 726, the controller may iterate through the entries 707 in the available blocks queue 706 starting from the front of the available blocks queue 706. If an entry 707 indicates an available block that was released (e.g., the freed block bit has a value of 1), then the controller may remove the entry 707 from the front of the available blocks queue 706 and add the entry 707 back to the end of the available blocks queue 706. If an entry 707 indicates an available block that was not released (e.g., the freed block bit has a value of 0), then the controller may remove the entry 707 from the front of the available blocks queue 706 without adding the entry 707 back to the end of the available blocks queue 706. In addition, as shown by reference number 728, the controller may update a bit for that block in the corresponding bitmap copy 705 of the bitmap queue 704 (e.g., which would be at the front of the bitmap queue 704) to indicate that the block is available. As the controller iterates through the entries 707, when the controller reaches an entry 707 for an available block having its boundary bit set to indicate that the block corresponds to a bit at an end position, as shown by reference number 730, the controller may remove the corresponding bitmap copy 705 from the bitmap queue 704 (e.g., after any update to the bitmap copy 705), and overwrite the corresponding bitmap 703 in the available blocks data structure 702 with the bitmap copy 705.

As indicated above, FIGS. 7A-7C are provided as an example. Other examples may differ from what is described with regard to FIGS. 7A-7C.

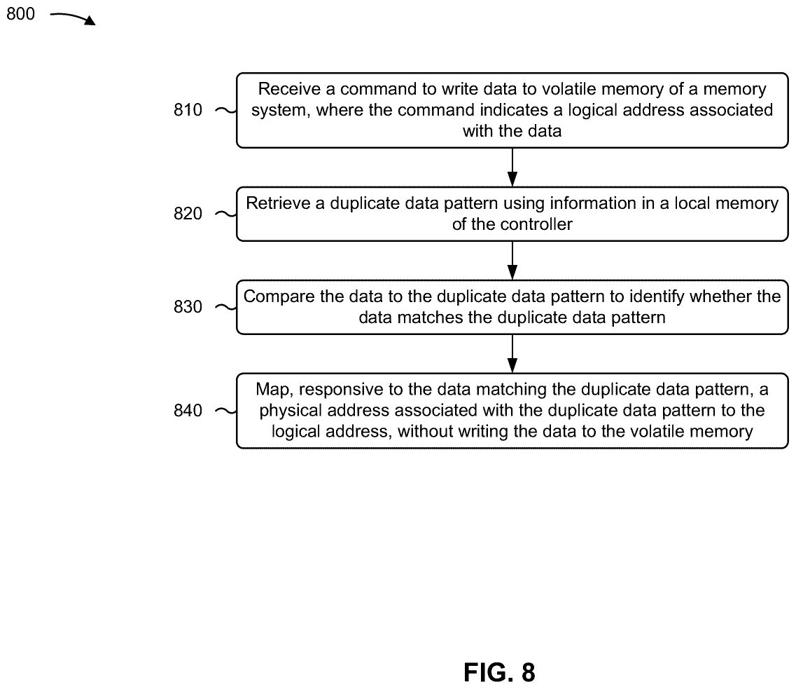

FIG. 8 is a flowchart of an example method 800 associated with online deduplication for volatile memory. In some implementations, a controller (e.g., the memory system controller 115, the CXL controller 220, and/or the central controller 224) may perform or may be configured to perform the method 800. In some implementations, another device or a group of devices separate from or including the controller (e.g., a local controller 125 and/or a memory controller 223) may perform or may be configured to perform the method 800. Additionally, or alternatively, one or more components of the controller (e.g., the deduplication engine 226) may perform or may be configured to perform the method 800. Thus, means for performing the method 800 may include the controller and/or one or more components of the controller. Additionally, or alternatively, a non-transitory computer-readable medium may store one or more instructions that, when executed by the controller, cause the controller to perform the method 800.

As shown in FIG. 8, the method 800 may include receiving a command to write data to volatile memory of a memory system, where the command indicates a logical address associated with the data (block 810). As further shown in FIG. 8, the method 800 may include retrieving a duplicate data pattern using information in a local memory of the controller (block 820). As further shown in FIG. 8, the method 800 may include comparing the data to the duplicate data pattern to identify whether the data matches the duplicate data pattern (block 830). As further shown in FIG. 8, the method 800 may include mapping, responsive to the data matching the duplicate data pattern, a physical address associated with the duplicate data pattern to the logical address, without writing the data to the volatile memory (block 840).

The method 800 may include additional aspects, such as any single aspect or any combination of aspects described below and/or described in connection with one or more other methods or operations described elsewhere herein.

In a first aspect, the method 800 includes deriving an entry address using the data, where retrieving the duplicate data pattern includes retrieving, from a data structure of the local memory of the controller, an entry associated with the entry address, where the entry indicates the duplicate data pattern and the physical address.

In a second aspect, alone or in combination with the first aspect, the method 800 includes deriving an entry address and a data representation using the data, where retrieving the duplicate data pattern includes retrieving, from a data structure of the local memory of the controller, an entry associated with the entry address, where the entry indicates a stored data representation and the physical address, comparing the data representation and the stored data representation to identify whether the data representation matches the stored data representation, and retrieving, responsive to the data representation matching the stored data representation, the duplicate data pattern from the physical address of the volatile memory.

In a third aspect, alone or in combination with one or more of the first and second aspects, the method 800 includes causing, responsive to the data not matching the duplicate data pattern, the data to be written to a particular physical address of the volatile memory, recording, in a data structure of the local memory of the controller, an entry indicating the particular physical address and a data pattern representing the data, where an entry address for the entry is derived using the data, and recording, in a content-addressable memory of the controller, association data indicating an association between the particular physical address and the entry address.

In a fourth aspect, alone or in combination with one or more of the first through third aspects, the method 800 includes receiving an additional command to read the data from the volatile memory, where the command indicates the logical address associated with the data, obtaining the physical address that is mapped to the logical address by a mapping of logical addresses to physical addresses, where the mapping includes a location indicator for the physical address that indicates whether the physical address is for the volatile memory or for a data structure of a local memory of the controller, retrieving duplicate data from the physical address of the volatile memory if the location indicator indicates the physical address is for the volatile memory, or retrieving a configured data pattern from the physical address of the data structure if the location indicator indicates the physical address is for the data structure, and returning the duplicate data or the configured data pattern in response to the additional command.

Although FIG. 8 shows example blocks of a method 800, in some implementations, the method 800 may include additional blocks, fewer blocks, different blocks, or differently arranged blocks than those depicted in FIG. 8. Additionally, or alternatively, two or more of the blocks of the method 800 may be performed in parallel. The method 800 is an example of one method that may be performed by one or more devices described herein. These one or more devices may perform or may be configured to perform one or more other methods based on operations described herein.

In some implementations, a system includes volatile memory; and a controller configured to: receive a command to write data to the volatile memory, where the command indicates a logical address associated with the data; compare the data to one or more duplicate data patterns to identify whether the data matches a duplicate data pattern of the one or more duplicate data patterns; and map, responsive to the data matching the duplicate data pattern, a physical address associated with the duplicate data pattern to the logical address, without writing the data to the volatile memory.

In some implementations, a method includes receiving, by a controller of a memory system, a command to write data to volatile memory of the memory system, where the command indicates a logical address associated with the data; retrieving, by the controller, a duplicate data pattern using information in a local memory of the controller; comparing, by the controller, the data to the duplicate data pattern to identify whether the data matches the duplicate data pattern; and mapping, by the controller and responsive to the data matching the duplicate data pattern, a physical address associated with the duplicate data pattern to the logical address, without writing the data to the volatile memory.

In some implementations, a system, including volatile memory; and a CXL controller, including: a CXL interface; and a controller configured to: receive a command to write data to the volatile memory, where the command indicates a logical address associated with the data; compare the data to one or more duplicate data patterns to identify whether the data matches a duplicate data pattern of the one or more duplicate data patterns; and map, responsive to the data matching the duplicate data pattern, a physical address associated with the duplicate data pattern to the logical address, without writing the data to the volatile memory.

The foregoing disclosure provides illustration and description but is not intended to be exhaustive or to limit the implementations to the precise forms disclosed. Modifications and variations may be made in light of the above disclosure or may be acquired from practice of the implementations described herein.

Even though particular combinations of features are recited in the claims and/or disclosed in the specification, these combinations are not intended to limit the disclosure of implementations described herein. Many of these features may be combined in ways not specifically recited in the claims and/or disclosed in the specification. For example, the disclosure includes each dependent claim in a claim set in combination with every other individual claim in that claim set and every combination of multiple claims in that claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

When “a component” or “one or more components” (or another element, such as “a controller” or “one or more controllers”) is described or claimed (within a single claim or across multiple claims) as performing multiple operations or being configured to perform multiple operations, this language is intended to broadly cover a variety of architectures and environments. For example, unless explicitly claimed otherwise (e.g., via the use of “first component” and “second component” or other language that differentiates components in the claims), this language is intended to cover a single component performing or being configured to perform all of the operations, a group of components collectively performing or being configured to perform all of the operations, a first component performing or being configured to perform a first operation and a second component performing or being configured to perform a second operation, or any combination of components performing or being configured to perform the operations. For example, when a claim has the form “one or more components configured to: perform X; perform Y; and perform Z,” that claim should be interpreted to mean “one or more components configured to perform X; one or more (possibly different) components configured to perform Y; and one or more (also possibly different) components configured to perform Z.”

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Where only one item is intended, the phrase “only one,” “single,” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. As used herein, the term “multiple” can be replaced with “a plurality of” and vice versa. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system, comprising:
volatile memory; and
a controller configured to:
receive a command to write data to the volatile memory,
wherein the command indicates a logical address associated with the data;
compare the data to one or more duplicate data patterns to identify whether the data matches a duplicate data pattern of the one or more duplicate data patterns; and
map, responsive to the data matching the duplicate data pattern, a physical address associated with the duplicate data pattern to the logical address, without writing the data to the volatile memory.

2. The system of claim 1, wherein the controller is further configured to:
derive an entry address using the data; and
retrieve, from a data structure of a local memory of the controller, an entry associated with the entry address,
wherein the entry indicates the duplicate data pattern and the physical address.

3. The system of claim 2, wherein the entry further indicates a reference counter indicating a quantity of logical addresses mapped to the physical address, and
wherein the controller is further configured to increment the reference counter responsive to the data matching the duplicate data pattern.

4. The system of claim 1, wherein the controller is further configured to:
derive an entry address and a data representation using the data;
retrieve, from a data structure of a local memory of the controller, an entry associated with the entry address,
wherein the entry indicates a stored data representation and the physical address;
compare the data representation and the stored data representation to identify whether the data representation matches the stored data representation; and
retrieve, responsive to the data representation matching the stored data representation, the duplicate data pattern from the physical address of the volatile memory.

5. The system of claim 4, wherein the physical address of the volatile memory is associated with a reference counter indicating a quantity of logical addresses mapped to the physical address, and
wherein the controller is further configured to increment the reference counter responsive to the data matching the duplicate data pattern.

6. The system of claim 1, wherein the controller is further configured to:
receive an additional command to read the data from the volatile memory,
wherein the command indicates the logical address associated with the data;
obtain the physical address that is mapped to the logical address by a mapping of logical addresses to physical addresses;
retrieve, from a content-addressable memory of the controller, an entry address associated with the physical address;
retrieve, from a data structure of a local memory of the controller, an entry for the entry address,
wherein the entry indicates a data pattern representing previously written data to the volatile memory; and
return the data pattern in response to the additional command.

7. The system of claim 1, wherein the controller is further configured to:
receive an additional command to read the data from the volatile memory,
wherein the command indicates the logical address associated with the data;
obtain the physical address that is mapped to the logical address by a mapping of logical addresses to physical addresses;
retrieve duplicate data from the physical address of the volatile memory; and
return the duplicate data in response to the additional command.

8. The system of claim 1, wherein the duplicate data pattern is a configured data pattern.

9. The system of claim 1, wherein the controller includes a content-addressable memory and a local memory,
wherein the local memory is configured to include at least one data structure, and
wherein the at least one data structure is configured to include the duplicate data pattern.

10. A method, comprising:
receiving, by a controller of a memory system, a command to write data to volatile memory of the memory system,
wherein the command indicates a logical address associated with the data;
retrieving, by the controller, a duplicate data pattern using information in a local memory of the controller;
comparing, by the controller, the data to the duplicate data pattern to identify whether the data matches the duplicate data pattern; and
mapping, by the controller and responsive to the data matching the duplicate data pattern, a physical address associated with the duplicate data pattern to the logical address, without writing the data to the volatile memory.

11. The method of claim 10, further comprising:
deriving an entry address using the data,
wherein retrieving the duplicate data pattern comprises:
retrieving, from a data structure of the local memory of the controller, an entry associated with the entry address,
wherein the entry indicates the duplicate data pattern and the physical address.

12. The method of claim 10, further comprising:
deriving an entry address and a data representation using the data,
wherein retrieving the duplicate data pattern comprises:
retrieving, from a data structure of the local memory of the controller, an entry associated with the entry address,
wherein the entry indicates a stored data representation and the physical address;
comparing the data representation and the stored data representation to identify whether the data representation matches the stored data representation; and
retrieving, responsive to the data representation matching the stored data representation, the duplicate data pattern from the physical address of the volatile memory.

13. The method of claim 10, further comprising:
causing, responsive to the data not matching the duplicate data pattern, the data to be written to a particular physical address of the volatile memory;
recording, in a data structure of the local memory of the controller, an entry indicating the particular physical address and a data pattern representing the data,
wherein an entry address for the entry is derived using the data; and
recording, in a content-addressable memory of the controller, association data indicating an association between the particular physical address and the entry address.

14. The method of claim 10, further comprising:
receiving an additional command to read the data from the volatile memory,
wherein the command indicates the logical address associated with the data;
obtaining the physical address that is mapped to the logical address by a mapping of logical addresses to physical addresses,
wherein the mapping includes a location indicator for the physical address that indicates whether the physical address is for the volatile memory or for a data structure of a local memory of the controller;
retrieving duplicate data from the physical address of the volatile memory if the location indicator indicates the physical address is for the volatile memory, or retrieving a configured data pattern from the physical address of the data structure if the location indicator indicates the physical address is for the data structure; and
returning the duplicate data or the configured data pattern in response to the additional command.

15. A system, comprising
volatile memory; and
a compute express link (CXL) controller, comprising:
a CXL interface; and
a controller configured to:
receive a command to write data to the volatile memory,
wherein the command indicates a logical address associated with the data;
compare the data to one or more duplicate data patterns to identify whether the data matches a duplicate data pattern of the one or more duplicate data patterns; and
map, responsive to the data matching the duplicate data pattern, a physical address associated with the duplicate data pattern to the logical address, without writing the data to the volatile memory.

16. The system of claim 15, wherein the duplicate data pattern is stored in a data structure of a local memory of the controller.

17. The system of claim 15, wherein the controller is further configured to:
derive an entry address using the data; and
retrieve, from a data structure of a local memory of the controller, an entry associated with the entry address,
wherein the entry indicates the duplicate data pattern and the physical address.

18. The system of claim 15, wherein the controller is further configured to:
derive an entry address and a data representation using the data;
retrieve, from a data structure of a local memory of the controller, an entry associated with the entry address,
wherein the entry indicates a stored data representation and the physical address;
comparing the data representation and the stored data representation to identify whether the data representation matches the stored data representation; and
retrieving, responsive to the data representation matching the stored data representation, the duplicate data pattern from the physical address of the volatile memory.

19. The system of claim 15, wherein the controller is further configured to:
cause, responsive to the data not matching the duplicate data pattern, the data to be written to a particular physical address of the volatile memory; and
record, in a data structure of a local memory of the controller, an entry indicating the particular physical address and a stored data representation of the data,
wherein an entry address for the entry is derived using the data.

20. The system of claim 15, wherein the controller is further configured to:
receive an additional command to read the data from the volatile memory,
wherein the command indicates the logical address associated with the data;
obtain the physical address that is mapped to the logical address by a mapping of logical addresses to physical addresses;
retrieve duplicate data from the physical address of the volatile memory; and
return the duplicate data in response to the additional command.
